(19) United States
(12) Patent Application Publication
(10) Pub. No.: US 2015/0031071 A1
(43) Pub. Date: Jan. 29, 2015

(54) Method and System for Distributing and Agitating an Amount of Liquid Over a Microscope Slide

(71) Applicant: VICTORIOUS MEDICAL SYSTEMS APS, Smørum (DK)

(72) Inventor: Lars Winther, Smorum (DK)

(73) Assignee: Victorious Medical Systems ApS, Smorum (DK)

(21) Appl. No.: 14/382,285

(22) PCT Filed: Mar. 1, 2013
(86) PCT No.: PCT/EP2013/054148

§ 371 Date: Aug. 29, 2014

Related U.S. Application Data
(60) Provisional application No. 61/605,346, filed on Mar. 1, 2012.

(30) Foreign Application Priority Data
Mar. 1, 2012 (EP) 12157712.6

(51) Int. Cl. G01N 1/30

(52) U.S. Cl. CPC G01N 1/30
USPC 435/30; 435/309.1

(57) ABSTRACT

A system and method for distributing and agitating an amount of a liquid over a microscope slide, wherein a distribution plate having a microtextured lower surface and at least one passage extending through the plate is secured at a predetermined distance of 10-250 μm above the microscope slide. Liquid passes through the passage in the distribution plate, and the distribution plate is transversely reciprocated relative to the microscope slide in the plane of the lower surface of the distribution plate or the plane of the upper surface of the microscope slide.

### TECHNICAL FIELD

The present invention relates to a method, system and a distribution plate for distributing and agitating an amount of a liquid, such as a reagent or a wash buffer, over a microscope slide. The slide normally carries a sample of tissue from a human or animal body for histological and/or cytological examination. Applications, to which the present invention may especially relate, include immunohistochemistry, in-situ hybridization, fluorescent in-situ hybridization applications, special staining, and cytology, as well as potentially other chemical and biological applications. One field of use of the invention relates to the treatment of patient tissue samples mounted on microscope slides in an automated staining apparatus. The invention also relates to aspects of increasing the rate of immunohistochemical and in situ hybridization staining of sectioned fixed tissue on a microscope slide, i.e. increasing the speed at which the bio molecules can diffuse into the fixed tissue from an aqueous solution placed in direct contact with the tissue section.

### BACKGROUND OF THE INVENTION

Cancer is a group of diseases caused by uncontrolled growth of cells followed by invasion of neighboring tissue and sometimes spreading to other parts of the body. Most cancers form tumors which can cause organ failures and are a leading cause of death globally.

Cancers are diagnosed and treated by oncologists. A definitive diagnosis often requires direct histological examination of a cancer specimen extracted by e.g. surgery, biopsy or autopsy. These specimens are examined in the anatomic pathology laboratory by staining techniques like haematoxylin and eosin (called H&E) primary staining and advanced staining, with immunohistochemistry (IHC) being the most widely used method.

Immunohistochemistry (IHC) is a technique involving the use of specific binding agents, such as antibodies and antibody fragments, to detect specific antigens that may be present in a tissue sample. Immunohistochemistry is widely used in clinical and diagnostic applications, for example to diagnose particular disease states or conditions, such as a cancer. For example, a diagnosis of a particular type of cancer can be made based on the presence of a particular marker antigen present in a sample obtained from a subject.

The anatomic pathology (AP) laboratory receives the fresh tissue or cell samples from a biopsy, surgery or autopsy. In a typical laboratory analysis workflow, the whole organ or tissue sample is dissected and described. Samples are cut (grossing) in smaller pieces and fixed in formaldehyde to preserve the structures and protect the tissue from degradation. The tissue is formalin-fixed in cassettes overnight, dehydrated in alcohol baths and embedded in paraffin blocks (tissue processing), from which thin sections (1-10 microns thick) are cut on a microtome. The formalin fixed and paraffin embedded (FFPE) tissue sections are mounted onto microscope slides and typically processed by two general pathways:

First, tissue sections are baked and dewaxed (deparaffinated) and stained by the general primary staining hematoxylin and eosin (H&E) method by treatment in a series of reagent baths in a simple and automated batch instrument. The H&E stained slides are cover slipped and examined by a pathologist using a bright field microscope for identification of cellular morphology and cytoarchitecture and diagnosis of disease states.

The rest of the slides are subjected to an optional second wave of more specific analysis, the so-called advanced staining, which visualizes specific proteins, genes or tissue structures in tissue sections selected based on the initial H&E staining.

As used herein, the term “sample” refers to any biological sample including biomolecules (such as proteins, peptides, nucleic acids, lipids, carbohydrates and combinations thereof) that is obtained from or includes any organism including bacteria or viruses. Biological samples include tissue samples such as biopsied tissue (for example, obtained by a surgical biopsy, a needle biopsy or fine needle aspirate (FNA)), cell samples (for example, cytological smears such as Papanicolaou smear (also called Pap smear), blood smears or samples of cells obtained by micro dissection), samples of whole organisms (such as samples of yeast or bacteria), cells and cultured cells or cell fractions, fragments or organelles (such as obtained by lysing cells and separating their components by centrifugation or otherwise). Other examples of biological samples include blood, serum, urine, semen, fecal matter, cerebrospinal fluid, interstitial fluid, mucous, tears, sweat, pus, nipple aspirates, milk, vaginal fluid, saliva, swabs, buccal swabs, or any material containing biomolecules derived. Samples also include reference or calibration material from, for example, cell cultures or of non-biological or artificial origin.

The term “sample” also refers to any of the states the material can be in during the treatment and staining. Including samples in the form of fresh, frozen, fixed, embedded, partly stained or stained samples.

One widely used advanced staining method is immunohistochemistry (IHC), which is an immunologically based method for visualizing proteins and structures in tissue for detection and diagnosis of cancers and other diseases. For IHC staining, the slides go through a number of complicated steps: (a) so-called baking to help adhere the thin tissue sections to the slide, (b) dewaxing to remove paraffin embedding media and fatty components in the tissue, (c) target retrieval or antigen retrieval by heat and buffer treatment or enzyme digestion, which partly reverses the effect of the previous formaldehyde fixation and also swells the tissue and (d) staining using a series of incubation with primary and secondary antibodies, numerous washing and blocking sequences, typically followed by secondary antibody-enzyme conjugates and chromogens or fluorescently tagged markers. The resulting staining pattern in the tissue is examined in a bright field or fluorescence microscope by the pathologist and is the basis for the diagnosis.

Various known histochemical and immunohistochemical stains requires the addition and removal of multiple reagents in a well defined sequence for specific time periods, at defined temperatures. Therefore, various instruments have been developed, which can perform a diversity of stains simultaneously under computer control, as specified by the technologist.

These instruments, referred to as “stainers” are robotic laboratory instruments with the capability to treat the slides with various reagents and controlled by software systems. Some stainers can perform multiple advanced staining protocols and some include the process steps of baking, dewaxing and target retrieval. Specific stainers are described below.

In clinical chemistry and microbiological laboratories samples, for example blood, urine or other samples from the patients, are distributed into a number of test tubes, vials or wells and processed by multiple procedures and on several automated platforms. The outputs from the various processes are numerical data or otherwise digitally processed data sets, which are easily combined to form the ultimate diagnosis without further need of the physical sample. This digitized output format is in strong contrast to the output in the anatomic pathology laboratory, where the processed sample slides from the entire patient case are most often inspected visually together and at the same time in order to obtain the diagnosis.

The pathologist makes the diagnosis by inspecting the entire case, i.e. primary and specific staining patterns and the cell and tissue morphology of the combined slides.

Also, the slide format itself makes the instrument, procedure and handling requirements different from that of e.g. the clinical chemistry laboratory. Vials, or other tubes, can be closed and securely hold, for example, treatment reagents and transported by robotics. The slide is flat, cannot hold the reagents and the sample can easily be scratched, dry out or otherwise be damaged.

Fully automated IHC and ISH advanced staining instruments, which include baking, dewaxing and target retrieval procedures have been introduced by Ventana Medical Systems Inc. (BenchMark™ and Discovery™), VisionBiosystem and Leica (Bond™), Celerus (Wave RPD) and BioGenex (16000, Xmatrix DX). In general, they are built either in a so-called carousel or matrix design.

An IHC advanced stainer design described in US2011136135A1 by Dako includes a number of movable slide racks, overhead robot, various processing modules, separate loading and on loading station and a storage module.

The automation of staining treatments has improved the staining quality and reduced the need for manual labour.

Various applications, such as in the field of immunology, may require processing sequences or protocols that comprise steps such as de-paraffinization, target retrieval, reagent application, and staining, especially for in-situ hybridization (ISH) techniques. In some applications, these steps may have been performed manually, potentially creating a time-intensive protocol and necessitating personnel to be actively involved in the sample processing. Even when performed automatically, there have been inefficiencies in such systems. Attempts have been made to automate sample processing to address the need for expedient sample processing and a less manually burdensome operation. However, such previous efforts may have not fully addressed certain specific needs for an automated sample processing system.

Previous efforts to automate sample processing may be deficient in several aspects that prevent more robust automated sample processing, such as: the lack of sufficient computer control and monitoring of sample processing; the lack of information sharing for processing protocol and processing status, especially for individual samples; the lack of practical information input and process definition entry capabilities; the lack of diagnostic capabilities; and the lack of real-time or adaptive capabilities for multiple sample batch processing.

Past efforts at automated sample processing for samples presented on carriers such as slides, such as U.S. Pat. No. 6,352,861 to Ventana Medical Systems, Inc. and U.S. Pat. No. 5,839,091 to Lab Vision Corporation, have not afforded the various advantages and other combinations of features as presented herein.

The rate of immunohistochemical and in situ hybridization staining of sectioned fixed tissue on a microscope slide is controlled by the speed at which the bio molecules can diffuse into the fixed tissue from an aqueous solution placed in direct contact with the tissue section.

The tissue mounted on the slide is partly swelled in liquid and forms a complex matrix with numerous cavities of different sizes, impregnable walls and both hydrophobic and hydrophilic areas. Diffusion of small molecules and especially larger bio molecules is difficult in such matrices.

The conjugate bio molecules used for staining of the samples include antibodies, DNA probes, and polymeric enzyme-antibody conjugates. They have molecular weights from a few kilo Daltons to thousands of kilo Daltons and all of them have a relatively large Stokes radius. The large size limits them to diffuse slowly into solid tissue with typical times for sufficient diffusion being in the range of several minutes to a few hours. Consequently, incubation conditions during staining procedures are typically 5 to 60 minutes at 30-37° C. followed by repeated washing steps to remove reagents after incubation.

The diffusion rate is driven by the concentration gradient so the rate can be increased by increasing the concentration of the conjugate in the reagent. These specialized reagents are, however, very expensive, meaning that an increased concentration is both wasteful and far too costly to be of practical use.

Also, excessive amounts of reagents with large molecular weight that are driven into the tissue when high concentrations are used, are easily entrapped in the tissue and are subsequently difficult to rinse out. This can cause high levels of non-specific background staining. Non-specific staining is just noise. In order to reduce the general noise and increase the signal-to-noise ratio of specific staining, current best practice dictates includes using low concentrations of conjugate bio molecules with long incubation times to allow the conjugate to find and bind to only the specific sites.

Attempts have been made to increase the reaction speed by adding various “free volume blocking” reagents like PEG and PVA or manipulating the salt concentration to help speed up the binding reaction. Unfortunately, this has not improved the resulting signal-to-noise ratio, as washing seems to be more difficult.

Also, the staining temperature plays a role for diffusion and reaction speed. Due to the nature of the staining reagents, especially the antibodies, the enzymes and the chromogens, the maximum temperature can normally not exceed 37-45° C. without denaturing e.g. the enzymes or antibodies—or changing the antibodies binding pattern. Also, higher temperatures can cause a faster dry-out of the sample mounted on the slide.

There continues to be a strong need for faster introduction of bio molecules into tissue sections for quicker processing and lower-volume reagent usage.

Similarly, the washing efficiency needs to be improved in order to improve the signal-to-noise ratio, reduce process time and reduce washing buffer volume. Improved washing efficiency must not increase the risk of destroying the sample integrity by e.g. drying out or dislodging the sample from the slide.

The staining process includes incubation with a series of reagents and wash buffers. In manual staining procedures, the different reagents or washing buffers are applied by pipette to the slide tissue in horizontal position. After incubation, the reagents are removed by tapping the slide in vertical position against a paper tissue or similar suction material. Further, any remaining drops hanging on the slide edge are often removed by carefully wiping with a tissue.

Alternatively, the reagents are removed by direct rinsing with tap water, a washing buffer or simple immersing the slide down into a bath of reagent or wash buffer.

The manual tapping method for removing the liquids is especially efficient prior to e.g. the antibody incubation, as there is a minimum of carry-over which would otherwise dilute the applied specific reagent in the next procedural step.

In automated systems, the removal of liquid during the washing cycle is done by two basically different systems: The use of an air knife or suction in a capillary gap.

The knife consists of a high intensity, uniform sheet of laminar air flow, sometimes known as streamline flow or curtain, which sweeps away the liquid.

The use of an air knife has several practical drawbacks, including the risk that the airstream dries out the thin tissue or small tissue array spots, resulting in a permanent damage to the tissue. After the subsequent staining, the dried out tissue areas can have the wrong staining intensity, higher background staining and changed morphology. Also, the air knife pushes the reagents over the slide edge and a portion of the liquid will be hanging underneath the slide, causing smears which obscure the optical clarity of the slides during the evaluation. Further, especially fatty tissue types, like breast or brain, can easily wrinkle or even be blown off the slide by the airstream.

The balance between the exact airstream, air knife geometry and timing of the applied buffer is important for an effective air knife washing cycle. Also, the slide surface will be cooled due to the rapid evaporation of liquids and the applied air stream. This is not beneficial for obtaining a staining system with near uniform temperatures.

The various air knife methods have proven to work in automated systems, but the fundamental problems with dry out artefacts and washing efficiency have not been addressed in a satisfactory way.

In some known autostainers, the reagents are dispensed to the slide at e.g. three different drop zones in order to cover the sample. The reagent then forms a static puddle of reagents over the tissue sample during the incubation. The stainer also uses the above described air knife system for removing reagents after incubation and as part of the washing procedure.

By merely having the reagent placed as a static puddle over the sample tissue or statically locked between slide and a cover slip, the necessary reaction time is controlled by the temperature, reagent concentration and the diffusion rates. As the reagents slowly diffuse into and eventually are consumed in the tissue, the reagent concentration decreases and further reduces the reaction speed. This can result in local reagent depletion and reduced staining efficiency. It should be understood, that there may be plenty of specific reagent in the bulk liquid in average but it is not evenly distributed in the liquid volume.

The disadvantage of having a static puddle of reagent on the slide is the low reagent reactivity efficiency due to reagent depletion near the target sample. Also, the volume of reagent needs to be sufficiently large to overcome surface tensions and the large area to be covered in order to completely and permanently cover the sample.

One problem common to most slide-based techniques with thin films of reagents is that convective transport processes are absent and reactants diffuse so slowly that assays may require hours or even days to reach equilibrium.

To overcome the reagent spreading and diffusion limitations, several researchers have introduced different techniques to control the flow and increase the motion of the reactants in slide-based assays.

In manual systems, techniques known from western blotting have been used for staining of samples mounted on slides, including submerging and rocking the slides in a diluted antibody solution. The agitation promotes diffusion of reagents, speeds up the reaction and compensates for diluted antibody concentration.

Examples of manual systems include the “Antibody Amplifier and Antibody Amplifier Eclipse™” (IHC WORLD, Woodstock, Md., 21163, USA). Similar shaking systems combining both heating and mechanical orbital rocking or shaking of the slides include the IQ Kinetic Slide Stainer™ (BioCare Medical, Concord, Calif. 94520, USA).

The active agitation or mixing of reagents during the treatment of slides has been sought solved by numerous methods for automated or semi automated stainers, as described in the following.

WO0107890 discloses a method for agitation the reagents on the slide. The individual slide is placed in a small plastic cassette. The slide and the concave top portion of the cassette forms a small capillary gap where the reagent used for treatment is applied, similar to the well-known Shandon system. The slide in the cassette is held in place by a spring. By applying force to the slide end, the small gap distance between slide and concave top wall is varied. Consequently, due to the capillary forces, the reagent is moved back and forth to promote agitation. The main drawback of this design is the difficult washing process of the single use plastic cassettes, the high demands for cassette accuracy and the mechanical complexity of aggregating multiple slides at the same time in an automated stainer.

A close variation of the above system is described in WO2010132893A1, incorporated in the Wave stainer made by Celerus Diagnostics (Carpinteria, Calif.—USA) and employing oppositely facing microscope slides attached to a special rack. The slides are mounted in pairs in a rack construct, which allows the slide pairs to change distance. By doing so, the created wave of liquids moves back and forth along the slide surface and effectively aggregates the reagents over the tissue sections mounted on the slides.

Both of the systems described above generate waves by using capillary forces and are mechanically complex. Also, the mixing is not gentle and a powerful sucking phenomenon occurs, which can detach the sample tissue section, the smears or cells from the slide.

Another approach to active mixing has been introduced by Advalytix AG (now part of Beckman Coulter). Their ArrayBooster™ system uses surface acoustic waves (SAW) to agitate volumes as small as 10 μl. Sound waves are sent from a generator underneath the slide, through the glass slide and into the liquid. By tuning the sound frequency and amplitude, small waves can be generated by the bouncing sound between the liquid and the air. This can generate small circular waves and agitation in the liquid.

In WO2006037332 the control and use of a surface acoustic wave mixing system for agitating reagents is specifically described for tissue stainers. One advantage of the system is the open and simple nature of the system. Washing and carry-over problems are the same as for simpler static staining systems. The main drawback of the SAW technology is the need for an efficient physical sound guiding contact between the sound generator and the slide. Further, the sound generator generates heat, which needs to be evenly distributed to get even staining conditions across the slide. Also, it is difficult to get the generated waves to cover the entire slide. Further, there is a risk of detachment of the tissue or cell samples on the slide due to the sound waves passing through the sample.

Another air/liquid system creating agitation in the thin liquid is disclosed in US2005153453A1, “Automated biological reaction apparatus” by Copeland et al. An airstream is applied to a water-immiscible liquid cover-slip oil covering the reagent, sample and slide and this creates a small vortex in the oil. The vortex movement drives the agitation in the thin aqueous reagent layer between the liquid oil cover slip and the glass slide. The liquid oil cover slip helps the spreading of the reagent over the sample and prevents rapid dry out. The disadvantage is the very low or negligible efficiency: This mixing is slow and not particularly vigorous and seems not to be efficiently transferred into the thin aqueous reagent layer. Further, the compressed airstream increases the general dry out risk of the thin tissue sample and reagents.

A similar two-liquid agitation and spreading technology is described in US 2005/0176026 A1 and is referred to as the Liquid-On-Liquid Mixing (LOLM) technology. The system uses a variation of the liquid cover slip system with a thick water-immiscible oil layer covering the reagent and sample on the slide. A mechanical stirrer aggregates the oil, creating a mixing pattern in the oil which is partly transferred into the thin aqueous layer below the oil. The LOLM set up resembles the Ventana air vortex described above, except that the LOLM mineral oil liquid cover slip is thicker and more viscous, and the LOLM method uses a rotating paddle to stir the mineral oil directly, unlike Ventana's method of directing air jets on the covering liquid. Also, the LOLM system is able to use smaller reactant volumes. The mixing is efficient but one serious disadvantage is the difficulty of combining thick oil layers on slides and small mixing paddles in an automated and integrated stainer with many slides. Also, the large volumes of oil can cause waste handling problems and it is difficult to clean the entire set up.

WO06012498A1 discloses a different reagent agitation system on slides, which utilizes a concave and thin mixing bridge which is moved across the entire length of the slide just over the sample. The distance between the bridge and the slide is so small that a moving liquid meniscus layer is formed between the two. This movement introduces agitation in the liquid. One serious disadvantage could be the mechanical and fluidic complexity and the need to adjust to e.g. substantial viscosity variations between different reagents in order to control the fluid.

Also, as for all techniques using curved or concave bridges, lids, cover slips or tiles for controlling the fluid on the slide, the distance and the reagent volume over the sample is always uneven across the slide. Therefore the reagents are inevitably unevenly distributed from the very beginning and throughout the operation.

US2011136135A1 discloses a stainer using a stainer arrangement with slides tilted at an angle. As with the Celerus Wave technology, a capillary gap is formed with a planar and solid lid covering the entire slide. Reagents and wash buffer are dispensed at the top of the capillary gap. It is stipulated that agitating of the reagents can be done by moving the upper lid back and forth while preserving the capillary gap. Thereby, the reagent does not run out. The disadvantage is the mechanical and fluidic complexity in controlling the reagents inside the gap against the gravity and still be able to effectively empty, fill and wash the sample and lid. Prevention of slide-to-slide carry-over from the lid is tried solved with a special washing slide with brushes and without sample.

On the above background, it is an object of embodiments of the invention to provide an improved method and system for distributing and agitating a liquid, such as a reagent and/or a wash buffer, over a surface of a microscope slide, which at least partially reduces the drawbacks of the prior art systems, which yet ensuring an even distribution of various types of reagents and/or wash buffers over the surface of the microscope slide. More specifically, it is an object of embodiments of the invention to provide a method and a system, which relies on simple components, and which is inexpensive to manufacture and assemble. It is a further object of embodiments of the invention to provide a system, which does not risk to impair the tissue sample on the microscope slide by liquid or other mechanical impact or heat.

### SUMMARY OF THE INVENTION

In a first aspect, the invention provides a method for distributing an amount of a liquid over a microscope slide, comprising:

(a) providing a distribution plate defining an upper surface and a microtextured lower surface, and at least one passage extending through the plate from the upper surface to the lower surface thereof;
(b) securing the distribution plate at a predetermined distance of 10-250 μm above the microscope slide with the lower surface of the distribution plate facing an upper surface of the microscope slide and with the distribution plate essentially overlapping the microscope slide, whereby a gap of 10-250 μm is provided between the upper surface of the microscope slide and the lower surface of the distribution plate;
(c) subsequently causing the liquid to pass through said passage in a direction from a passage inlet at the upper surface of the distribution plate towards a passage outlet at the lower surface of the distribution plate;
(d) transversely reciprocating the distribution plate relative to the microscope slide in a direction substantially parallel to the plane of the lower surface of the distribution plate or the plane of the upper surface of the microscope slide, while said liquid is present in the gap between the upper surface of the microscope slide and the lower surface of the distribution plate;
(e) causing at least some of the amount of liquid, which exits said passage outlet at the lower surface of the distribution plate to distribute equally in said gap between the upper surface of the microscope slide and the lower surface of the distribution plate under the action of capillary forces caused by the surface tension between the liquid and the microtextured lower surface of the distribution plate.
In a second aspect, the invention provides a system for distributing an amount of a liquid over a microscope slide, comprising:
a distribution plate defining an upper surface and a microtextured lower surface, and at least one passage extending through the plate from the upper surface to the lower surface thereof;
a mechanism for securing the distribution plate at a predetermined distance of 10-250 μm above the microscope slide with the lower surface of the distribution plate facing an upper surface of the microscope slide and with the distribution plate essentially overlapping the microscope slide;
a supply of the liquid arranged to cause the liquid to pass through said at least one passage in a direction from a passage inlet at the upper surface of the distribution plate towards a passage outlet at the lower surface of the distribution plate;
a structure for transversely reciprocating the distribution plate relative to the microscope slide in the plane of the lower surface of the distribution plate or the plane of the upper surface of the microscope slide.

In the system according to the second aspect of the invention, at least some of the amount of the liquid, which exits said passage outlet at the lower surface of the distribution plate, distributes equally between the upper surface of the of the microscope slide and the lower surface of the distribution plate under the action of capillary forces caused by the surface tension between the liquid and the microtexture at the lower surface of the distribution plate. Due to the relative transverse reciprocating movement between the microscope slide and the distribution plate, the liquid is agitated at the same time to achieve improved mixing within the gap. In other words, the rate of immunohistochemical and in situ hybridization staining of sectioned fixed tissue on a microscope slide is increased due to the fact that the speed at which bio molecules can into the fixed tissue from an aqueous solution placed in direct contact with the tissue section is increased.

The distribution plate is also referred to as “grid” or “mixing grid” herein.

The passage through the distribution plate is also referred to as a “drop channel” herein.

The terms “upper”, “above”, “lower” and “below” as used herein should not be understood to mean upper, above, lower and below with respect to gravity. These terms rather designate a mutual relationship between the microscope slide, distribution plate and/or other parts in a reference system, in which the microscope slide is below the distribution plate. The entire setup, assembly or system may be turned upside down or rotated at any angle without compromising the function of the invention.

It should be understood that, at the step of transversely reciprocating the distribution plate relative to the microscope slide, the microscope slide may be reciprocated while the distribution plate is at stand still. Alternatively, the distribution plate may be reciprocated, while the microscope slide is at standstill. In a yet further alternative, both the microscope slide and the distribution plate may be reciprocated.

The invention also provides an automated apparatus for staining of a plurality of biological samples arranged on microscope slides held in mutually fixed positions in a frame, also referred to as a rack, said automated apparatus comprising:
a system according to the second aspect of the invention;
a liquid reagent supply for supplying a liquid reagent to the system;
a liquid wash buffer supply for supplying a liquid wash buffer to the system;
a controller for controlling the supply of said liquids to said passage, wherein the controller is configured to supply the liquid reagent to at least one of the microscope slides held in the frame and to simultaneously supply the liquid wash buffer to at least another one of the microscope slides held in the frame.

The a structure for transversely reciprocating the distribution plate relative to the microscope slide according to the second aspect of the invention may be an integrated part of such apparatus.

The invention also provides a distribution plate for a system according to the second aspect of the invention for distributing a liquid over a microscope slide, the plate defining an upper surface and a microtextured lower surface and at least one passage extending through the plate from the upper surface to the lower surface thereof.

It should be understood that a tissue sample of a human or animal body may be provided on the upper surface of the microscope slide. Preferably, the tissue sample does not make contact with the distribution plate.

The microtextured lower surface of the distribution plate arranged at a distance of 10-250 μm above the microscope slide ensures that the liquid, which exits the passage outlet at the lower surface of the distribution plate distributes equally in the gap between the upper surface of the microscope slide and the lower surface of the distribution plate under the action of capillary forces caused by surface tension between the liquid and the microtextured lower surface of the distribution plate. Thereby, a system is provided, which is inexpensive and mechanically simple in that it obviates the need for further mechanical, fluidic, acoustic, air knife or other means for achieving even distribution of the fluid over the microscope slide. The system further results in the benefit that the tissue sample on the microscope slide is not affected or impaired by such means.

In the present context, the term “microtextured lower surface” should be understood to mean that the lower surface of the distribution plate is provided with a textured pattern, i.e. a pattern of grooves of indentations, which have a peak-to-valley height in the range of about 1 μm to about 100 μm.

On a macroscopic scale, the lower surface of the distribution is preferably planar. In other words, seen in a direction orthogonal to the plane defined by the lower surface, no point at the lower surface is more than 100 μm offset, in said orthogonal direction, from any other point at the lower surface.

Preferably, the lower surface of the distribution plate is microtextured over an area of at least 30-50% of its total surface area. In preferred embodiments, the microtextured surface extends over at least 70% of the lower surface of the distribution plates, such as over at least 80% or 90% or over the entire lower surface.

In preferred embodiments of the invention, at least 50% of the lower surface of the distribution plate is non-planar. In the present context, the term non-planar is to be understood as non-planar on a microscale in the order of the peak-to-valley depth of the grooves or indentations forming the mictrotextured surface.

Preferably, any straight-line distance, measured in the plane of the lower surface of the distribution plate, between neighbouring indentations, grooves or protrusions forming the microtextured pattern of the lower surface of the distribution plate is smaller than an amplitude of the reciprocating movement of distribution plate relative to the microscope slide. This reduces the risk of leaving liquid spots on the microscope which are not being agitated. In respect of a standard microscope slide the amplitude of the reciprocating movement is preferably in the range of 2-10 mm, such as between 3 and 6 mm. Hence, the said straight-line distance between neighbouring grooves, indentations or protrusions should not exceed these dimensions. Preferably, the straight-line distance does not exceed 5 mm.

The present invention include a general method for distributing and agitating an amount of a liquid over a microscope slide.

In the following, an general example of operation is described:
i. The slide mounted with the sample and the dry grid is put together
ii. The gap between the slide and the dry grid is filled by dispensing a small volume (100-150 micro liter) of reagent in the drop channel.
iii. The reagent (e.g. primary antibody, link antibody, visualization reagent, chromogen etc.) is allowed to incubate while being mixed by moving the slide transversally.
iv. The reaction is stopped by dilution by dispensing a larger volume (500-5000 micro liter) of wash buffer in the drop channel. The wash buffer slowly runs through the structures and over the slide edge while being agitated.
v. The large washing buffer volume dispensing and agitation step is repeated
vi. Grid and slide are separated by tilting the slide downwards and the grid is cleaned with an efficient air knife. The slide is kept away from the air knife and any remaining liquids are allowed to run off passively from the surface.
vii. Slide and dry grid are reassembled for the next procedural step and reagents.

Subsequent to steps (b), (c), (d) and (e) of the method according to the present invention, the method may comprise the further steps of:
cleaning the distribution plate and the microscope slide by causing an amount of a washing liquid to flow across the distribution plate and the microscope slide; and
separating the distribution plate and the microscope slide to allow the washing liquid to be removed from the distribution plate and the microscope slide; and subsequently:
repeating steps (b), (c), (d) and (e).

By separating the microscope slide and the distribution plate, any liquid caught in the gap between the grid and the slide may be efficiently removed.

Preferably, in the present invention there is no flow of liquid into or out of the gap between the microscope slide and the distribution plate, while the distribution plate and the microscope slide are being mutually reciprocated when the liquid is a reagent solution (e.g. antibody, molecular probes, secondary link antibody, enzyme-antibody conjugates, chromogenes, dyes, special stains, dehydration, rehydration or counter-staining reagent). When the liquid is a washing liquid, preferably a flow of the washing liquid into and out of the gap between the microscope slide and the distribution plate is provided, while the reciprocating movement occurs.

The gap between the microscope slide and the distribution plate is preferably in fluid communication with a surrounding atmosphere to allow air, gas or liquid to escape in the event of, e.g., an increase of pressure caused, for example, by development of gas or by thermal expansion.

The passage in the distribution plate may be emptied by moving the distribution plate and the microscope slide relative to each other to a position, in which the passage outlet is beyond the microscope slide. Such movement may preferably occur in the plane of the reciprocating movement of the microscope slide and/or the distribution plate, so that motion means causing the reciprocating movement for distribution of the liquid also cause the movement to said position, in which the passage outlet is beyond (i.e. does not overlap with) the microscope slide.

Generally, the distribution plate (“grid”) can be made of a number of materials and combinations of materials.

Preferred metals include aluminum, silver and titanium.

Preferably, the grid should not leak e.g. ions, which can potentially catalyze unwanted chromogen precipitation.

Preferred polymers include several thermoplasts and cross linked polymers, for example high density polyethylene or propylene, Polyoxymethylene (POM), polyether ether ketone (PEEK), polycarbonates and nylons.

Polymers, like some nylons, which are suited for 3D printing are preferred. Similarly, polymers suited for laser cutting are preferred.

Preferable coating include several of the diamond-like carbon (DLC) coatings, titanium aluminum nitride (TiAlN) or aluminum titanium nitride (AITiN) coating, various glass coating techniques, including SiO₂ ultra-thin layering, so-called spray-on liquid glass coating.

HDPE and DLC coated metals are especially preferred grid materials due to the high resistance to abrasion and low coefficient of friction. These are important properties, as the rail is resting on the glass slide and repeatedly moved back and forth to promote agitation.

In one preferred design, the passage through the distribution plate (the drop channel) is attached to a funnel, which captures the dispensed liquids; the staining reagents and washing buffer. The funnel allows the liquid to be raised over the slide and grid, and consequently, increase the pressure and increase the flow speed into the gap between the grid and slide. The surface of the funnel should be smooth or coated to prevent liquid from hanging, facilitate cleaning and prevent carry-over.

Even more preferably, the funnel allows the dispensing of liquids from a robotic pipette while the mixing grid is moved longitudinally, transversally or circularly over the slide.

The funnel can be an integrated part of the grid or attached to the grid.

Flow of fluid in between two infinite parallel flat plates driven by the motion of one or more of the plates is often referred to as Couette flow. The Couette flow has no acceleration, no net pressure forces, and no net convective transport of momentum. Because of this, the governing equations describing the flow profile also say that the net viscous force on any control volume is zero. Further, at small distances between the plates the Reynolds number for Couette flows is very low.

Consequently, the mixing efficiency between layers of the liquid between the plates is very low.

The distribution plate is preferably rectangular. The distribution plate preferably overlaps the microscope slide. Accordingly, the lower surface of the distribution plate has dimensions at least equal to the dimensions of the staining area of a standard microscope slide, i.e. at least 25×55 mm. The distribution plate may be wider in one or both directions. In preferred embodiments of the invention, the distribution plate has a thickness of between 0.1 and 100 mm, such as between 10 and 100 mm if the plate is made from plastics, such as Nylon™ or between 10 and 50 mm if the plate is made from a metal, such as Aluminium.

In order to enhance fluid distribution in the gap between the lower surface of the distribution plate and the upper surface of the microscope slide, the distribution plate may be transversely reciprocatable in the plane defined by its lower surface, while the liquid distributes in the gap between the upper surface of the microscope slide and the lower surface of the distribution plate.

Washing the distribution plate may in some instances be facilitated if it is wider than the microscope slide.

The microtextured lower surface of the distribution plate preferably comprises a pattern of grooves or indentations having a depth, i.e. peak-to-valley depth, of at least 10% of the distance between the upper surface of the microscope slide and the lower surface of the distribution plate, such as between 10% and 100%, or between 25 and 100%. Experience has shown that mixing is particularly efficient with grooves or indentations of such depth in respect of herringbone or staggered herringbone microtextures in the lower surface of the plate.

The microtextured lower surface of the distribution plate comprises at least one of:
a pattern of zig-zag grooves;
a pattern of staggered grooves;
a pattern of herringbone grooves;
a pattern of staggered herringbone grooves;
a chessboard pattern.

The at least one passage extending through the distribution plate, through which the liquid is supplied, may comprise at least one of:
a hole provided centrally in the distribution plate;
a matrix of a plurality of holes distributed over the distribution plate;
a slit extending a longitudinal direction of the plate;
a slit extending transversely to a longitudinal direction of the plate.

At least a circumferential inner surface of the passage is preferably hydrophobic. The distribution plate may itself be made from a hydrophobic material, or at least the circumferential inner surface of the passage through the distribution plate may be coated with a hydrophobic material.

The at least one passage through the distribution plate preferably has a cross-sectional area in the plane of the upper and/or lower surface of the plate of between 0.1 and 10% of the total area of the upper or lower surface, such as e.g. between 1 and 10% thereof.

Excess liquid, which is not accommodated in said gap between the upper surface of the microscope slide and the lower surface of the distribution plate, may conveniently be caused to flow off one or more edges of the microscope slide by the action of gravity. Accordingly, no exact metering of the amount of liquid supplied to the passage in the distribution plate is required, whereby liquid dosage control is facilitated. Excess liquid may be collected in containers or compartments provided below the microscope slide in the system and apparatus according to the invention.

A mechanism for securing the distribution plate above the microscope slide may comprises a pair of rails at or near respective parallel side edges of the microscope slide. The rails may e.g. be provided at respective parallel side edges of the microscope slide extending transversely to a longitudinal direction of the slide. The rails may preferably have a width of 0.05-4 mm, such as from 0.5 to 2 mm. The length of the rails is preferably approximately equal to the or longer than the width of the microscope slide. In one embodiment, the rails extend beyond the edges of the microscope slide in order to prevent droplets of liquid from being drawn back.

Herein, the distribution plate is also referred to as “grid”.

### DETAILED DESCRIPTION OF THE INVENTION

Technical solutions to reduce the incubation time by improving the diffusion rate by reagent mixing and agitation is associated with solving the other major care-abouts during staining of slides, including
a. Complete spreading of low volume reagents over the sample mounted on the slide
b. Effective multidimensional agitation
c. Efficient washing procedures to reduce reagent carry-over
d. Low volume of wash buffer to reduce the amount of accumulated waste
e. Easy and robust integration of mechanics and fluidics in a stainer
f. Individual staining of slides, with no slide-to-slide spill over

The present inventor has found that the current methods for spreading the reagent over the sample mounted on the slide and agitating the reagents during incubation can be greatly improved.

The inventor has realized that the most efficient method to agitate the reagents and to promote a homogeneous reagent distribution is by directly agitating the reagent as opposed to indirect agitation through e.g. airstreams, stirring paddles in a liquid cover slip or through surface acoustic waves.

The inventor has also realized that efficient mixing and agitation of the reagents to promote diffusion in and out of the tissue matrix requires the flow patterns to be multi dimensional instead of a merely one-dimensionally laminar flow over the sample. By simply moving a thin reagent layer back and forth in parallel to and over the tissue sample mounted on the slide, as in e.g. US2011136135A1, the generated one-dimensional laminar flow pattern will not result in an efficient diffusion vertically into and out of the dense tissue matrix. The liquid boundary layers separating the liquids in the tissue matrix and the liquids above will predominantly remain intact. This will be even more pronounced if the protein or salt concentration, viscosity or density is different in the layers of liquid, as for example during reagent incubation and during washing procedures.

The inventor has concluded that the mixing technology should avoid any sucking phenomena or other violent mixing methods as in e.g. the Celerus Wave technology, which can detach the sample tissue section, the smears or cells from the slide. Also, the set up should never expose the sample directly to the air during the staining or washing steps.

The inventor has realized that in order to obtain the right balance between protecting the tissue from drying out and yet obtain efficient washing and consequently low carry-over, the tissue should be allowed to remain fully swelled at all times, never be exposed to conditions promoting drying-out, and in particularly never subjected to an airstream. During washing the swelled tissue should be allowed to naturally hold as much liquid as possible and the surplus allowed to run off the slide.

At the same time, the inventor has realised that an air knife has been proven to be very efficient in removing liquids from flat or structured surfaces and is well suited for automatic instruments.

The present invention provides a simple method for fast staining and washing of biological samples arranged on slides, by directly agitating the reagents on the slide and using an air knife in an indirect mode.

The invention is also directed to an apparatus for contacting a biological sample suspected of containing a biomarker with a solution containing a conjugate bio molecule, comprising a platform for supporting a microscope slide having a biological sample thereon, a translating grid having a surface positioned above the platform, the surface being in proximity to a biological sample when in operation; means for moving the translating grid back and forth over the biological sample; and means for applying liquid solution containing the conjugate bio molecules to and from the grid.

Surprisingly, it is possible to rapidly spread, hold and agitate the reagent using a solid device
called the grid or distribution plate—without touching or detaching the sample tissue mounted on the slide.

The grid works by holding the reagent in place by capillary forces in the device and between the device and the slide and tissue section.

Further, embodiments of the grid include a micron scale patterned structure with different distances between the device and the slide. Thereby, the flow pattern includes both parallel and perpendicular flows when the device is moved in parallel to the slide surface.

The grid can be designed to have a channel suited for the reception of the dispensed reagents and wash buffers.

Also, by agitating the reagent, the efficiency of the reagent is increased and the concentration can potentially be reduced. The reduced concentration further makes it economically feasible to use a larger volume of reagent, which further reduces any dry out problems.

The grid and the slide can be separated and the grid cleaned for liquids by an air knife stream before being put together. Thereby the sample mounted on the slide remains wetted at all times and the grid can be efficiently cleaned when separated from the slide and sample.

The grid can contain a number of design elements, including:
Supporting rails
Mixing structures
Fluid guiding channel
Air holes
Reagent drop channel, and
Fixture anchoring points

The grid is in the following the general term used for the device holding, mixing and controlling the fluid on the slide, referred to herein also as the distribution plate. The grid is a generic term for all the designs covered by this invention.

By the term “below” or “under” is meant the side or face of the grid which faces the microscope slide. Similarly, the term “above” or “over” is used to describe the side of the grid facing away from the slide.

The supporting rails or supporting columns are the structures supporting the grid on the standard 25 mm×75 mm (1″×3″) microscope slide. The height of the rails is from 10-150 microns, preferably 30-80 microns and even more preferably 30-75 microns. They touch the slide on the top, bottom or side of the slide. Preferably 1-5 mm from the glass edge, from the label on top of the slide or the edge at the bottom of the slide. During movement of the grid, the staining zone (23×50 mm) is not touched nor is the sample at risk of being scratched.

The mixing structure under the grid is a highly textured surface with repeating longitudinal or transversal ribs, lamellae or bristles structures or randomly positioned columns with different height. Preferably, the height, distance and depth dimensions are approximately the same dimensions as the average height between the grid and the slide surface, about 10-200 microns, preferably 25-150 microns and even more preferably 30-100 microns. This allows for the best mixing.

The optional fluid guiding channel is a 25-500 microns deep and wide channel in the mixing structure. The guiding channel allows fast transport of the liquid past across the mixing structure. Thereby the spreading speed can be further enhanced. The channel can be e.g. longitudinal or transversal in relation to the slide.

The optional air holes go through the grid and allow trapped air to escape. The holes are preferably 100-2000 microns wide, distributed over the entire grid in a random or repeated pattern and go all the way through the grid. The holes can be treated with a hydrophobic coating to predominantly allow air to pass.

The preferred grid materials include aluminum, stainless steel, ceramics, polymers like polypropylenes, polyethylene, poly carbonates, silicones or nylons or similar industrial materials which can all be manufactured with the desired micron scale structures.

The surface coating is preferably chemically inert and optionally hydrophilic to promote fast wetting. Preferred coatings include various fluorinated polymers, glass coating, oxidizes, nitrides or carbides. The coating can make the grid surface harder, hydrophilic or hydrophobic. Methods for applying such coating are well-known and include gaseous depositions, vapor treatment, painting, etching and various plasma treatments.

The coating can be hydrophilic in e.g. the mixing structure and hydrophobic around the drop channel and on the sides of the grid to guide the liquid. Especially the rails and the side of the grid can be hydrophobic to prevent liquids sipping into the label area or liquid to be lifted back during the mixing.

During mixing and washing the grid is moved back and forth over the biological sample. The movements are transversal (sideways), longitudinal (lengthwise), circular or concentric. The movements may be 1-20 mm with a speed of 0.05 to 30 mm/second.

The preferred movement is transversal +/−5-15 mm, such as +/−2-8 mm, with a speed of 0.1-2 mm/second, such as 0.1-1 mm/second. Thereby, the reagent is kept in the gap between the grid and the slide during incubation steps, and during washing steps excess liquid is allowed to run from the drop channel through the gap while being mixed and over the sides of the slide. The longitudinal movements mix and agitate the liquid and also push the excess liquid over the side.

The drop channel or hole is designed to receive, store and guide the reagent or wash fluid fast from the drop zone above the grid to cover the entire staining zone under the grid. The drop channel is a V or U shaped and concave structure used for confining, storing and guiding the fluid. The drop channel allows the fluid to access the other side end of the grid and helps to distribute the liquid evenly across the slide. Further, the drop channel can hold both small amounts of reagent liquid (50-250 micro liters) and larger wash buffer volumes (250-5000 micro liters). Thereby, the drop channel acts as an intermediate reservoir for the wash buffer while it sips into the gap between grid and slide. Also, the drop channel allows the reagent to be dispensed at only one drop zone with e.g. an automatic dispensing robot—and still be distributed over the entire slide staining zone. The drop zone does not need to be located very precisely, which makes it more robust and easy to integrate into the stainer's reagent delivery systems.

The drop channel can be at any location of the grid. Though, most preferably, the drop channel is in the middle of the grid extending from near the top to the bottom. Thereby, the liquid is distributed fast and can quickly cover the entire staining area. Also, the reagents are restricted from running into the label area. Reagents sipping into the label area can cause unwanted discoloration or even label detachment.

Preferably, the drop channel has a depth which allows the larger volume wash buffer to stand 2-30 mm above the slide surface to promote a faster flow-through speed during washing.

Also, the drop channel can be connected to a larger funnel, which can guide the dispensed liquid into the drop channel while it is being moved.

In an alternate embodiment, the grid may be heat conductive and attached to a controllable heat source—or it may even be a heat source itself—so that it can conduct heat to and from the liquid and the sample. The heat source is preferably an electric heater and coupled to a temperature feed back mechanism. This arrangement is highly desirable as the contact area between the liquid and heated grid is large and therefore facilitates a fast heat exchange, making it possible to efficiently to change, hold and control the temperature of the liquid and the sample during processing.

In yet an alternate embodiment, the device grid may be electrically conductive so that it can conduct an electric current through the tissue when the grid is positioned in proximity to it and grid and tissue are in electrical contact through an electrolytic solution. The benefit of electrical conductivity is that charged molecules can actively be driven into the tissue via electrophoresis. Further, an electrophoresis flow will promote diffusion and thus increased reaction speed.

The washing and cleaning process may be carried out by separating the slide from the horizontal grid and tilting the slide to a near vertical position and ideally more than 90 degrees away from the grid.

By separating slide and grid, the liquid will be divided into three portions: (i) The grid will hold a portion of the liquid in its interior, which can be removed to a waste pan with an efficient air knife, (ii) a large portion of the liquid will run off the slide and down in the waste pan due to gravitational forces, and (iii) a small portion of the liquid will be held in the swelled tissue mounted on the slide.

Any remaining drops of liquid hanging on the lower part of the slide in the vertical position can be removed by gentle touching with a spring or similar device which breaks the surface tension.

By separating the grid and the slide, liquid caught in the gap between the grid and slide is efficiently removed. The grid and the slide bearing the sample can therefore be treated by different cleaning processes. The highly structured grid part can be repeatedly air knife cleaned and even sprayed with wash buffer at elevated temperatures or other harsh procedures, whereas the liquid on the delicate sample mounted on the microscope slide is gently allowed to run off while the sample remain swelled and humid to protect against dry-out and preserve its integrity.

There are several words which can be used with the same meaning as mixing without significant difficulty or confusion. These include stirring, blending, agitation or kneading,

It should be understood that the preferred structured surface during the movements will contribute to the agitation and mixing in several ways.

First, moving the steep mountain-valley 50 micron scale pattern back and forth will induce circular fluidic movements up and down in the narrow gap between the grid and slide.

Secondly, the series of mountain-valleys form a more macroscopic landscape with characteristic lengths of 100 s of micrometers. For example, in the form of the diagonal, staggered or asymmetrical herring fish bone pattern. By moving the grid back and forth, the pattern will guide groups of many small fluidics circles first in one direction—before they are split and recombined with other groups of fluidic circles.

This will result in the preferred mixing pattern introducing both microscopic fluidics movements up and down between the sample mounted on the microscope slide and the grid and larger fluidic movements in many directions, including fluidic movements parallel to the slide and nearly perpendicular to the direction of the grid movement.

Preferable, the characteristic length between the corners in the grids herring fish bone pattern or other patterns are of the same magnitude as the grid movements, to optimize the larger fluidic movements both parallel and perpendicular to the direction of the grid movements.

Consequently, the combined fluidic movements during agitation will equalize any reagent concentration differences at both the local hot spot in the sample and over and between larger sample sections on the slide.

The homogeneity of the agitation action impacts both speed of the reagent diffusion and reaction time. Hence, higher homogeneity enhances the possibility of obtaining the same staining conditions over the entire slide.

Reagent agitation during e.g. antibody or visualization reagent incubation is preferably carried out with the same small volume of reagent. Preferably no reagents are allowed to run through the gap between the grid and slide due to gravitational flow or active pumping. Thereby the expensive reagent solution can be utilized as efficiently as possible.

During the reagent incubation, the agitation is done by moving the grid microtexture through the otherwise static solution caught between the grid and slide. This is fundamentally different from the use of passive micromixers, using various baffles or structures to mix a fluidic stream.

On the micro scale, mixing is movement of solute between fluid elements, and takes place only via diffusion between fluid layers. Mixers reduce the time necessary for this process by redistributing the fluids, decreasing the necessary length for diffusion and increasing the probability for solute transport between fluids.

In micro fluidics the Reynolds number is small, preventing turbulence as a tool for mixing, while diffusion is that slow that time does not yield an alternative.

The mixing method in the present invention is similar to methods used in mixing and agitating fluids flowing in channels in e.g. micro and nano scale lab-on-a-chip systems, in small sensors and so-called motionless mixers.

Motionless mixers often have static split and recombine (SAR) design elements, which repeatedly split the fluidics stream, twist the streams and recombine the streams, resulting in an efficient mixing. The design concept of SAR comes directly from the fluidics stretching-folding mechanism of chaotic advection.

SAR systems include static mechanical obstacles in the form of squares, columns, saddles, edges, walls and corners which forces the fluid stream to split and recombine.

Of particular relevance for the present invention are mixing patterns adapted from chaotic advection mixers, such as the staggered herringbone mixer (SHM) which are widely used in lab-on-a-chip systems, due to their efficiency and simple fabrication and operation.

The family of mixing patterns includes the grooved staggered herringbone and similar structures with distinct and sharp edges placed in a pattern, which promotes seemingly random movements of the fluidics body in several directions.

It should be understood that in the present invention, the mixing grid is moved and the liquid is caught between the microscope slide and the grid.

The mixing structures similar to the staggered herringbone mixer are characterized by the peak-to-peak or valley-to-valley pitches and Péclet number, which is a measure of convective versus diffusive solute motion.

It should be understood that the present invention is suited for spreading, agitating and removing both small and larger volumes of liquid. Also, as the grid is also an efficient mixing device, the washing cycle can be conducted according to several different protocols.

In the following, an general example of operation is described:
i. The slide mounted with the sample and the dry grid is put together
ii. The gap between the slide and the dry grid is filled by dispensing a small volume (100-150 micro liter) of reagent in the drop channel.
iii. The reagent (e.g. primary antibody, link antibody, visualization reagent, chromogen etc.) is allowed to incubate while being mixed by moving the slide transversally.
iv. The reaction is stopped by dilution by dispensing a larger volume (500-5000 micro liter) of wash buffer in the drop channel. The wash buffer slowly runs through the structures and over the slide edge while being agitated.
v. The large washing buffer volume dispensing and agitation step is repeated
vi. Grid and slide are separated by tilting the slide downwards and the grid is cleaned with an efficient air knife. The slide is kept away from the air knife and any remaining liquids are allowed to run off passively from the surface.
vii. Slide and dry grid are reassembled for the next procedural step and reagents.

Note that the above washing procedure is simplified and that the set up also allows for continuously substituting the reagent with fresh wash buffer while being agitated. In theory, this should be more efficient than batch washing of the slide.

With the above described mode of operation, a number of slides can be attached to a frame or rack and each slide can be treated with different specific reagents using different incubation times before reaction stop by dilution and washing with different volumes.

In a different method of operation, the reagent (e.g. DAB chromogen) can be dispensed several times without a washing step, or without the separation and air knife cleaning of the grid done in between washing steps.

In yet another mode of operation, the slide and grid can be separated after incubation with the small volume reagent.

Preferred embodiments of the invention results in several advantages compared to prior art, including:
i. Reactions and washing procedures are efficient and faster by applying agitation, which speeds up diffusion processes in the specimen and prevents local reagent depletion.
ii. Upon application reagents are more homogeneously distributed across the tissue specimen, resulting in a homogeneous staining.
iii. The slides do not need to be perfectly aligned horizontally.
iv. The reagents and buffers can be applied at one drop zone.
v. Potential carry-over from e.g. washing step to reagent treatment step is efficiently distributed and therefore diluted in the next step
vi. Specimens are not in risk of drying out.
vii. Larger volumes can be applied to the specimen
viii. Makes it possible to mix reagents on the slide (e.g. chromogens)

### DESCRIPTION OF THE FIGURES

FIGS. 1 to 11 are photographs of the various grids seen from above, from below or resting on microscope slides.

FIG. 1: 1st generation mixing grid as seen from above: (A) The central hole allows reagents and wash buffers to sip slowly into the gap between the grid and the slide.

FIG. 2: 1st generation mixing grid as seen from below: (A) The central hole allows reagents and wash buffers to sip into the gap between the grid and the slide. (B) Rails supporting the grid at each side of the slide and holding the grid 50 microns above the slide surface. (C) Repeating 50 micron mixing structure covering the entire grid. The uneven colors are due to a laser malfunction during preparation and an optical artifact (D) The grid is open at top and bottom or slide and grid to allow liquids flow out

FIG. 3: 2nd generation mixing grid as seen from above: (A) The channel at the top allows reagents and wash buffers to sip quickly into the gap between the grid and the slide.

FIG. 4: 2nd generation mixing grid as seen from below: (A) The channel at the top allows reagents and wash buffers to flow quickly into the gap between the grid and the slide. (B) Supporting rails at each side raise the grid 50 microns above the slide surface. The liquid can run out through the openings at the top and bottom of the grid. (C) Repeating 50 micron mixing structure. (D) The structure has a small longitudinal flow-guiding channel for faster distribution of the liquid.

FIG. 5: 2nd generation mixing grid as seen from below during test of the washing sequence. The microscope slide is fixed to a laboratory stand (blue) and the grid is resting on the support rails on each side of the microscope slide. The 50 micron gap between the slide and grid was filled with 150 micro liter water. The channel at the top is filled with 2000 micro liter of washing water which sips through the gap between the slide and the grid. Water can be seen dripping out at the bottom. Water is also flowing out at the top of the slide. Also, the mixing microstructure is clearly visible through the slide and the water.

FIG. 6: 3rd generation mixing grid as seen from the above: Multiple small holes can be seen covering the entire grid to allow air to escape.

FIG. 7: 3rd generation mixing grid as seen from below: (A) Multiple holes allowing air to escape. (B) Supporting rails at each side raise the grid 50 microns above the slide surface. The liquid can run out at opening at top and bottom of grid. (C) The repeating 50 micron mixing structure.

FIG. 8: 4th generation mixing grid as seen from above: (A) The central drop channel allows reagents and wash buffers to be distributed evenly along the slide.

FIG. 9: 4th generation mixing grid as seen from below: (A) The middle drop channel allows reagents and wash buffers to be distributed evenly along the slide. (B) Supporting rails at top and bottom of slide raise the grid structure 50 microns above the slide surface (C) Repeating 50 micron transversal mixing structure and (D) The small flow-guide channel.

FIG. 10: 4th generation mixing grid as seen from above resting on the support rails at top and bottom 50 microns above the microscope slide. The microscope slide is held by the laboratory bench fixture (blue).

FIG. 11: 4th generation mixing grid seen from below through a mirror. The grid rests on the support rails at top and bottom of the microscope slide. The 50 micron gap between the slide and the grid is filled with 150 micro liter water. The transversal 50 micron mixing structure is clearly visible through the slide and the water. Also, the small transversal flow guide channel is seen.

FIG. 12 illustrates a cross-sectional of the microscope slide, tissue sample, liquid and mixing structure, i.e. distribution plate or “grid” with microtextured lower surface.

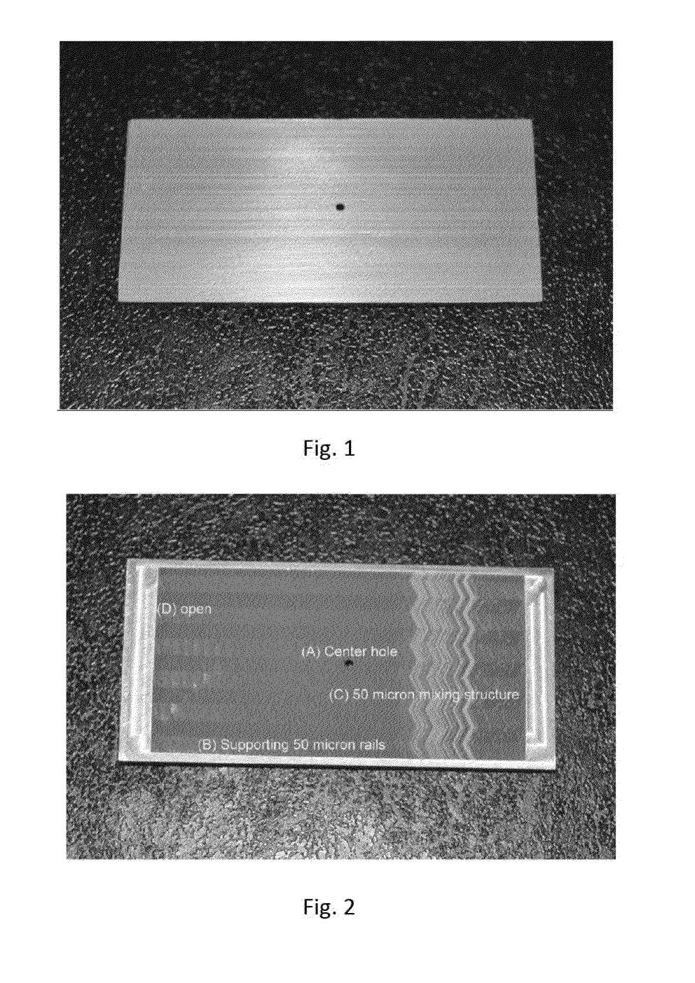

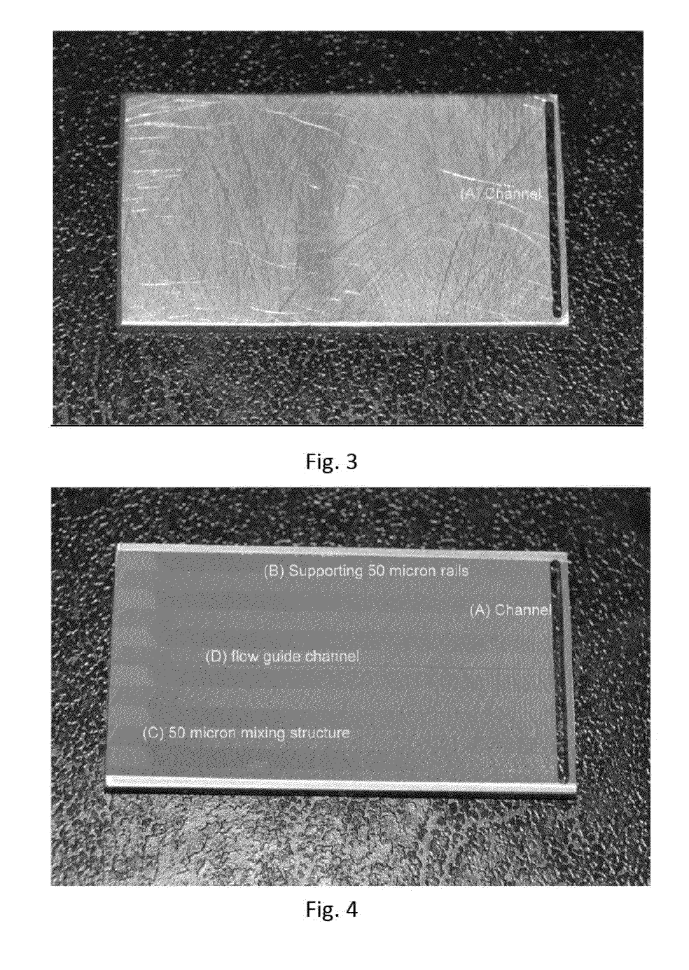

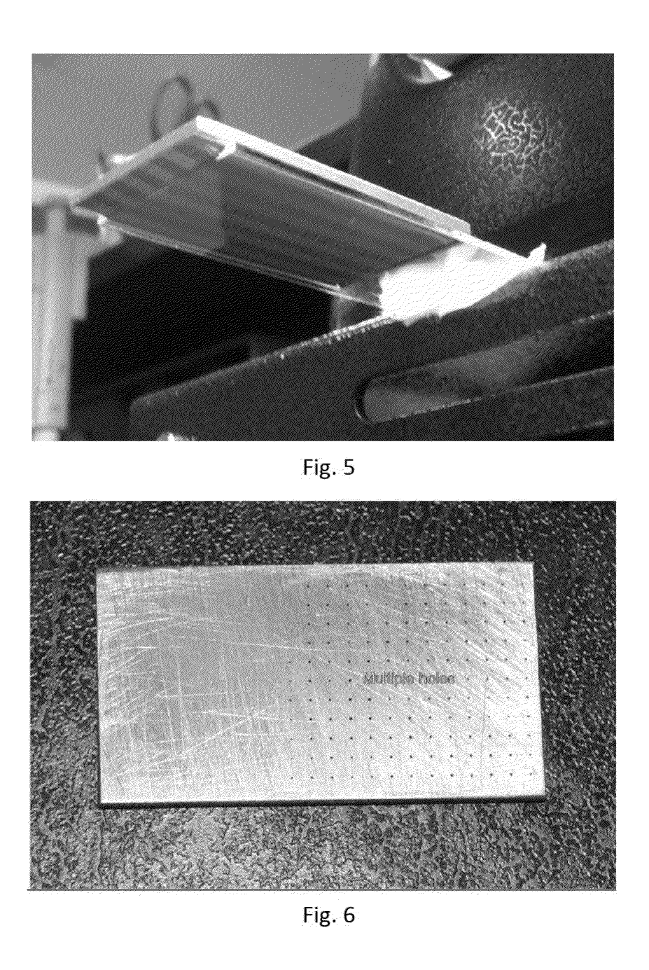

Generally, the herringbone pattern can be described as a series of very steep mountain ranges with deep narrow walleyes and sharp peaks. The mountain ranges are e.g. placed in long zigzag patterns, in symmetrically repeated patterns or in a unsymmetrical, random or staggered pattern to increase the split and recombine effect and consequently mixing efficiency.

In the Stokes flow regime, where viscous forces dominate, the fluid stream will be disrupted in the grooves and walleyes cause transverse flow in the walleyes resulting in two counter-rotating vortices along the walleye length.

Flow mixing patterns have been calculated and simulated for numerous herringbone mixers. It was e.g. found that for grooves or valleys deeper than 30% of the fluid channel height, mixing is greatly improved. Thus, in order to improve the mixing quality in staggered herringbone micro mixers, it is generally advised to use a mixer with deep grooves, having a depth of 30-100% of the channel height.

Similarly in the present invention, the groves should preferably be of the same dimension as the distance between the microscope slide and the moving mixing grid.

Other patterns similar to the herringbone structures include the chessboard mixer and multilaminated/elongational flow micro mixer.

These patterns include design structures with arrays of high columns and rectangles of same or different lengths placed close to each others. Similar to the herringbone mixers, they also work by the split and recombine effect—and other effects.

By orienting the various mixing elements in a particular dimension, the fluid can be directed in a particular direction.

This is especially relevant for the present invention, as the fluid on the microscope slide can be directed away from e.g. the label area or away from the drop channel or hole or directed to the middle of the slide and sample or towards the slide edge for removal.

Near the sharp edges on the obstacles, other effects than the split and recombine effect add to the mixing efficiency.

In the present invention these extra mixing effects can come from the outer edge of the mixing grid and the edges in the drop channel while the grid is moved longitudinally or preferably transversally over the slide.

In the present invention, one preferred method of obtaining the herringbone mixing structure is by CNC laser cutting and routing. The laser spot follows a pre-programmed zigzag pattern and slowly removes material from the surface. The more times the laser spot passes a particular location, the deeper the cut and the deeper the valley in e.g. the herringbone mixing structure. The resulting structure is like a series of mountain ranges with sharp peaks, and repeated plateaus down to the valley.

This simple procedure allows preparation of virtually any mixing structure.

One preferred herringbone structure has a repeated zigzag pattern of 2 by 1 mm, 15 micro meter between the plateaus, 50 micro meter between the peak-to-peak pitches and a valley depth of about 50 micro meter. The dimensions in the structure were verified by reflectance microscopy.

This mixing structure is preferred in conjunction rails resulting in an average distance between the mixing grids peaks and the microscope slide of 50-75 micrometers.

The longitudinal or preferably transversal movement is 2-15 mm—even more preferable 2-8 mm. This covers an area similar to or larger than the typical tissue section or area of diagnostic interest.

FIGS. 13 to 20 illustrate various locations and designs of the drop channel in the mixing grid.

During the longitudinal or transversal movement of the grid over the slide the drop channel edges add to the liquid mixing efficiency.

Also, the figures illustrate various lengths and widths of the supporting rails, including rails longer or shorter than the mixing structure as well as multiple rails supporting the grid.

FIG. 13 illustrates a simple centered drop channel. The rails are shorter than the mixing structure.

The configuration of FIG. 15 has an ellipsoidally shaped drop channel, allowing the dispensed liquid to be dropped slightly off-centered, e.g. during slide movement.

FIG. 15 illustrates a snake-like drop channel design, which allows distribution over a large part of the slide, dispensing liquid off-centered during movements.

FIG. 16 illustrates a complex star-like drop channel design.

FIGS. 17 to 20 illustrate various drop channel designs which are simple to manufacture and allow for both off-centered dispensing, spreading over a large area and additional mixing effects during longitudinal, transversal or circular movements of the grid over the slide.

FIG. 17 illustrates grid rails which are longer and more narrow. The figures also illustrate a rail design with several shorter rails or columns.

FIGS. 21 to 31 illustrate various mixing structures in the mixing grid. The structures have characteristic heights, depths and peak to peak distances of 1-200 micrometers and are easy to make by e.g. laser cutting or stamping processes.

FIGS. 21 to 23 illustrate examples of angled structures placed in ordered patterns, in random patterns and different angles.

FIGS. 24 to 27 illustrate examples of various columns and prism structures placed in different patterns. The structures have different heights and angles, all promoting the mixing efficiency.

FIGS. 28 to 30 illustrate examples of various fish bone and mountain range structures with different heights, valley widths and angles. FIG. 30 is a combination of a mountain range/fish bone structure and a column structure.

FIGS. 31 and 32 are microphotographs of a fish bone structure, laser cut in aluminum with a distance between peak-to-peak and peak-to-valley of about 40-50 micrometers.

In FIG. 32, the same fish bone structure is shown at a lower magnification to show the zig-zag pattern and the flow channel.

FIG. 33 illustrates a Nylon grid with raised funnel at the drop channel and extended rails, as seen from above (left) and from below (right).

FIG. 34 illustrates the fish bone structure used in Nylon grids, such as the grid of FIG. 33 (left) with the zig-zag pattern designed for efficient split and recombine agitation and characteristic distances between the valley corners of about 2-4 mm. The microphotograph (right) illustrates laser cut structure with peak-to-peak distances of about 420 micrometers and peak-to-valley distances of about 70 micrometers.

### EXAMPLES

In the following examples, different design generations of grids are described and some of their properties tested in a manual or automatic set-up.

The general method of preparation was the following:

The mixing grid was made from a rectangular 5 mm plate of aluminum type (Alumeco, type EN AW-5457) and cut into approximately 45×25 mm. Milling removed 70 micrometer, leaving 1 mm wide rails on each side.

The mixing structure was created as an e-drawing (AutoCAD and saved in the dxf format) before being imported into the controlling scanner software (RayLase).

The mixing structure was created using a CNC laser cutting instrument (Ultra short pulsed Clark-MXR CPA 2161).

The laser spot followed the programmed zigzag pattern and removed material from the surface during multiple passes overnight.

The resulting herring bone-like structure had 2 by 1 mm zig-zag mountain ranges, 15 micrometer between the plateaus, 50 micrometer between the peak-to-peak pitches and a valley depth of about 50 micrometer.

The mixing structure was confirmed and the dimensions recorded in a reflectance microscope.

The longitudinal mixing pattern had mountain ranges zig-zaging from side to side of the grid (short distance). A “transversal pattern” was with ranges and valleys predominately from top to bottom of the grid (long distance).

Flow guide channels were cut analogously to the mixing pattern.

Drop hole or drop channels were milled before the laser cutting.

### Example #1

Generation #1 grid was designed with a 1 mm drop hole in the middle and supporting rails at each side. When placed on the slide, the gap is open at the top and bottom.

The mixing structure was of the longitudinal direction design, with the zig-zag mountain range stretching from side to side of grid.

The peak-to-valley distance was measured to 55 micrometers on average.

The grid is illustrated in figures #1 and #2 as seen from above and below.

Due to a laser malfunction during preparation, the process was stopped. After correcting the CNC program error, the structure was finished. Therefore, the mixing structure appeared to have an uneven colorization in the surface. This is an optical artifact due to different levels of oxidation.

In a manual testing set up, a standard 25 mm×75 mm (Superfrost, Menzel, Germany) microscope slide was attached horizontally to a laboratory elevator at the label end. A mirror was placed under the slide and a standard desk top spot light mounted for ease of observation. A digital camera (Nikon D5100, jpg format) and a hand held HD film camera (Apple Corp. Iphone 4, mov format) was used to record the filling and washing performance. 125 microliter of plain water (Type 2, MilliQ) was dispensed by pipette on the drop hole. Within 2 seconds, the water was sucked into the hole and completely filled the gap between the grid and slide as seen from below through a mirror and digitally recorded.

The grid was moved manually approximately 10 mm longitudinal back and forth more than 10 times within approximately 2 minutes. No water escaped and the gap remained completely filled during the movement.

To test the washing behavior, 1000 microliter water was dispensed onto the hole on top. Immediately, water slowly began to sip into the hole and out of the gap at the top and bottom of the slide. During movement, this flow appeared to be faster.

The gap remained filled during the washing test.

The slide and grid was separated and the grid cleaned by pressurized air.

The 125 microliter filling, grid moving and washing experiment was repeated 5 times with the same result. No air bubbles were observed.

The entire experiment was repeated with water containing 0.05% w/w Tween 20 (PEG(20)sorbitan monolaurate, Aldrich P1379).

The gap between the grid and slide was filled within a second. No other difference in performance was observed.

### Example #2

Generation #2 grid was designed with a 1.5 mm wide and 22 mm long drop channel 2.5 mm from the top of the grid and supporting rails at each side. When placed on the slide, the gap was open at the top and bottom.

The mixing structure was of the longitudinal direction design. Also, a flow guide channel (42 mm long and 50×50 micrometer deep) was introduced in the middle of the grid.

The grid is illustrated in figures #3 and #4 as seen from above and below. The set up is illustrated in figure #5.

The performance was illustrated in the same way as in example 1.

The drop channel was added 125 microliter water, which fast filled the gap between grid and slide. Very little water sipped into the label area.

When dispensing 2000 micro liter of washing water in the drop channel, the water quickly sipped through the gap between the slide and the grid. Water could be seen slowly dripping out through the top and bottom of the gap between slide and grid.

Manual longitudinal movements of the grid increased the flow speed. Surprisingly, a large portion of the water ran all the way from the top drop channel and to the bottom gap and out. Some of the water sipped out through the top gap near the slide label area.

No air bubbles were recorded and the gap remained completely filled during the washing test, even after the drop channel was emptied.

### Example #3

Generation #3 grid was prepared as above without drop channel or flow guiding channel and designed especially for monitoring the performance in relation to trapped air. The grid had an array of holes of 100 micrometer placed a distance of 2.2 mm from each other.

The grid is illustrated in figures #6 and #7 as seen from above and below.

The gap between the grid and slide was partly filled with tween20 containing water and air bubbles were tried captured. After several attempts air bubbles were caught in the gap and their behavior recorded digitally as previously described.

By manually moving the grid repeatedly in the longitudinal direction about 10 mm back and forth, the air bubble did not remain static and moved rapidly in the longitudinal direction and disappeared within 4-8 seconds. The experiment was repeated three times with similar results. The air seemed to disappear through the holes and through the gap at the top or bottom.

### Example #4

A generation #4 grid was prepared with a transversal mixing direction design. That is, with the zig-zag mountain range and valleys dominantly stretching from top to bottom of the grid. A 42 mm long and 1 mm wide drop channel was milled in the middle of the grid.

Also, a flow guide channel (50×50 micrometer deep) was introduced in the middle of the grid from the drop channel and out to each side.

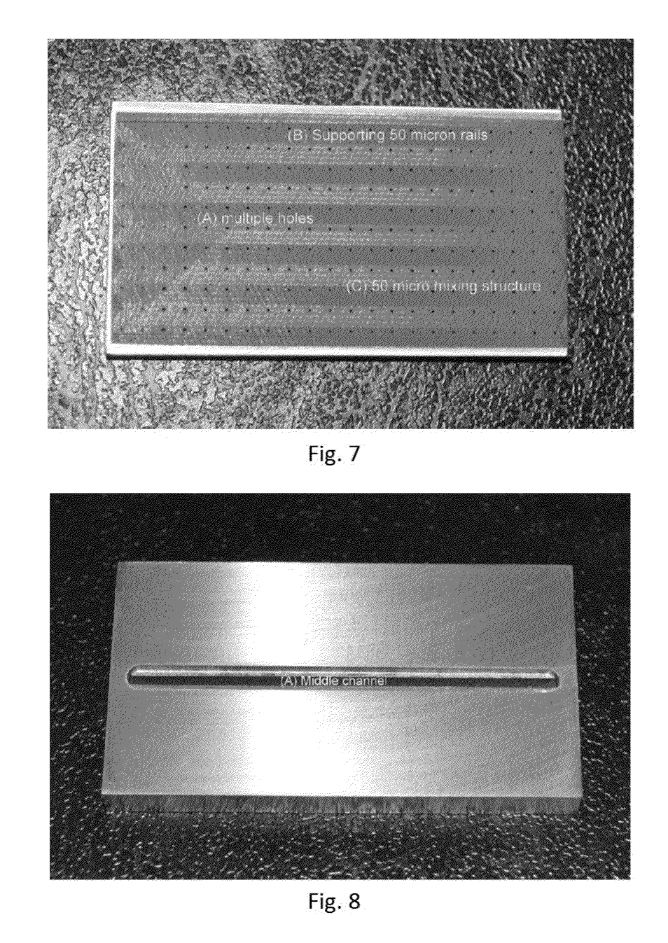

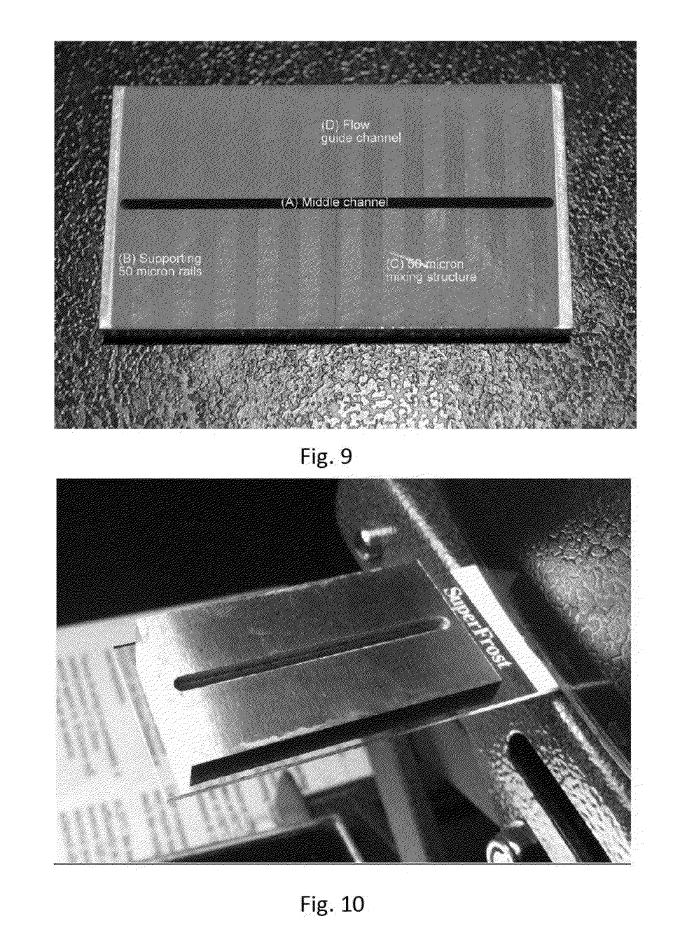

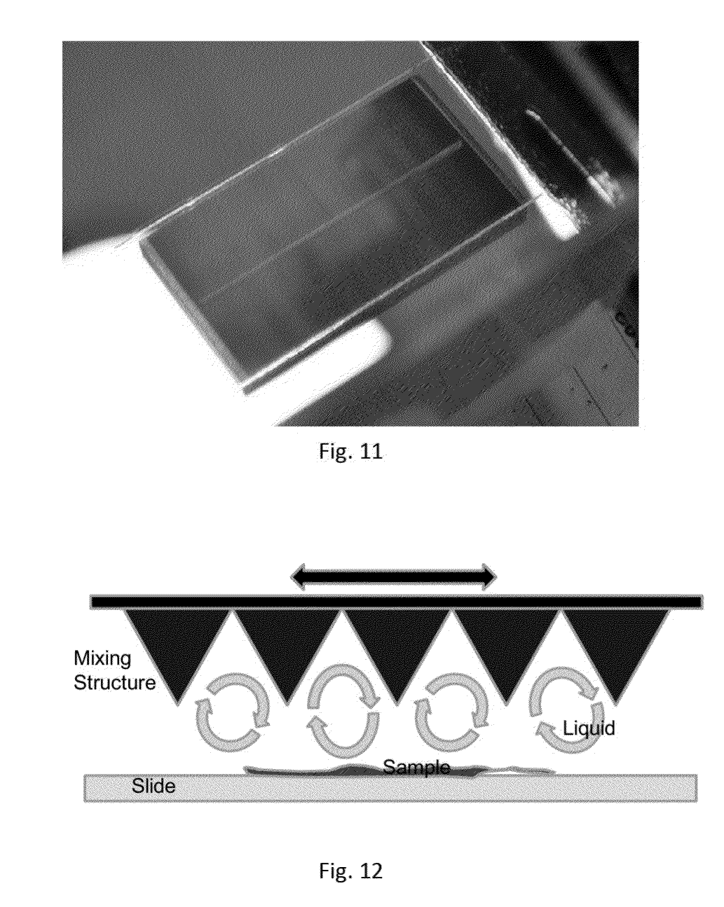

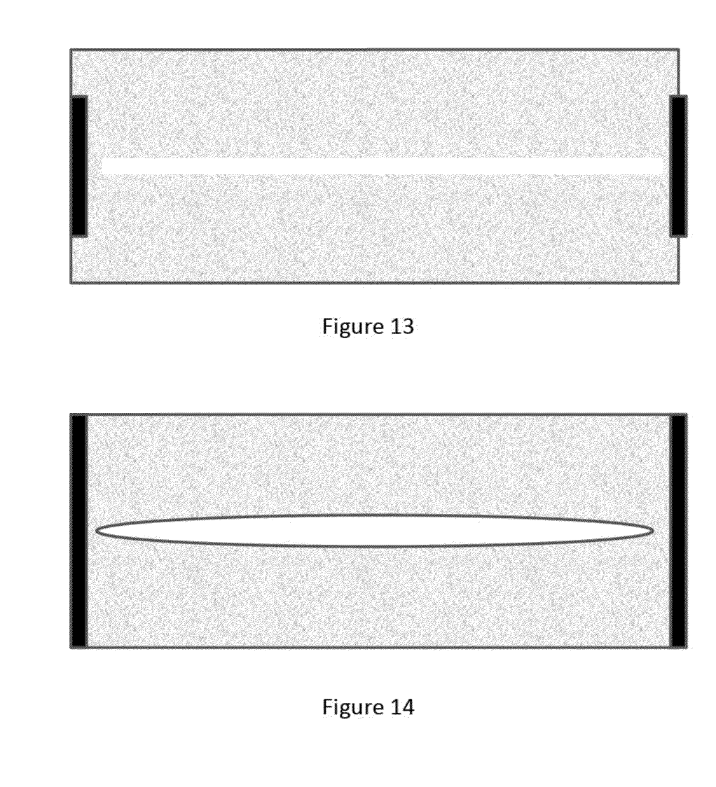

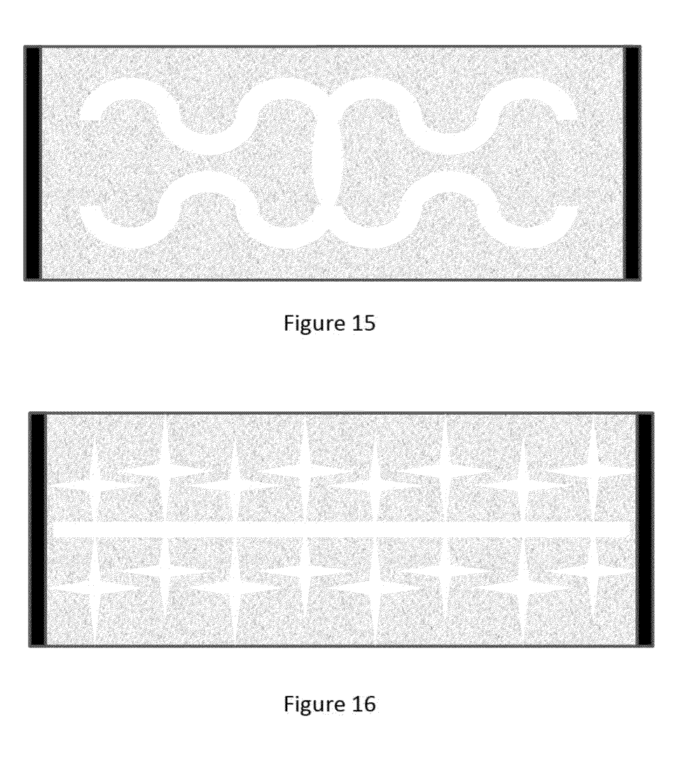

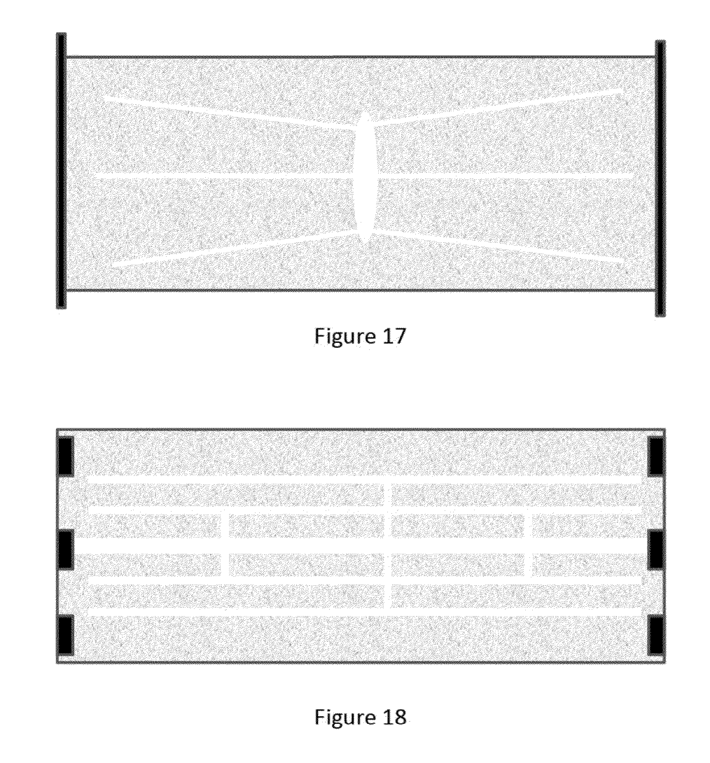

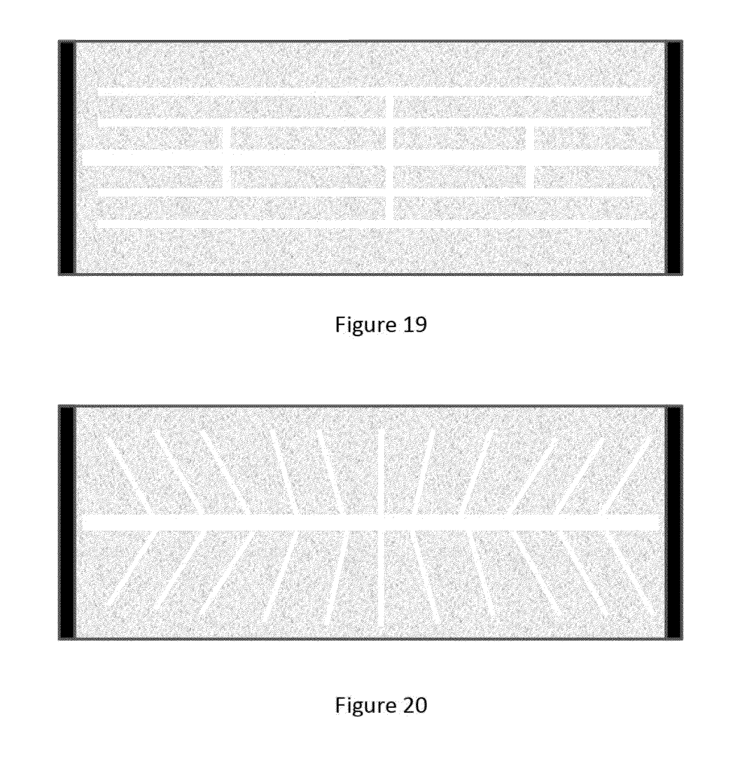

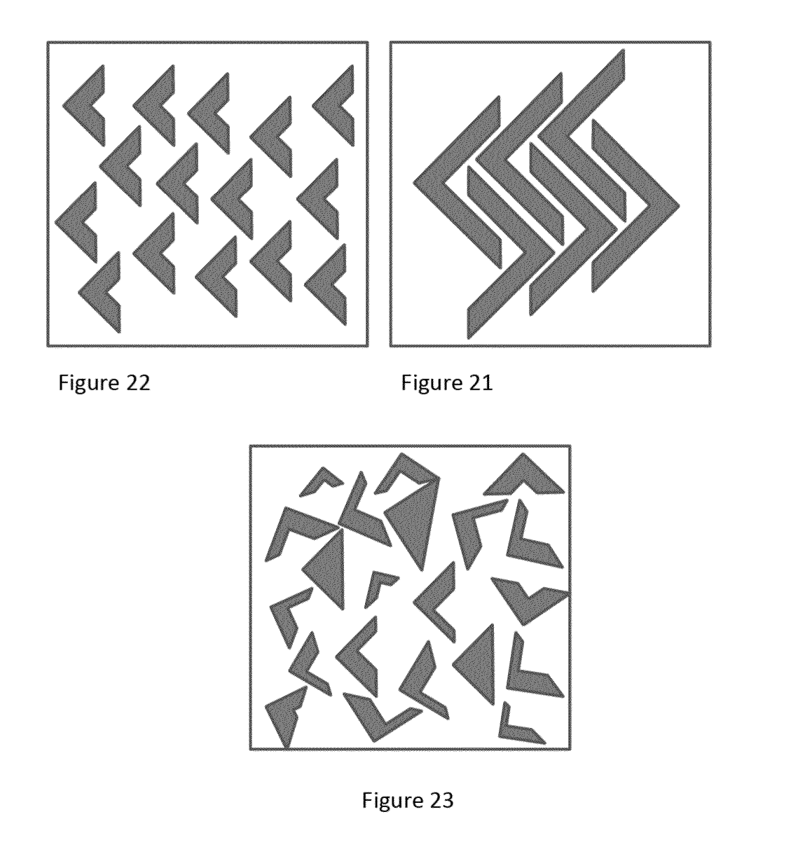

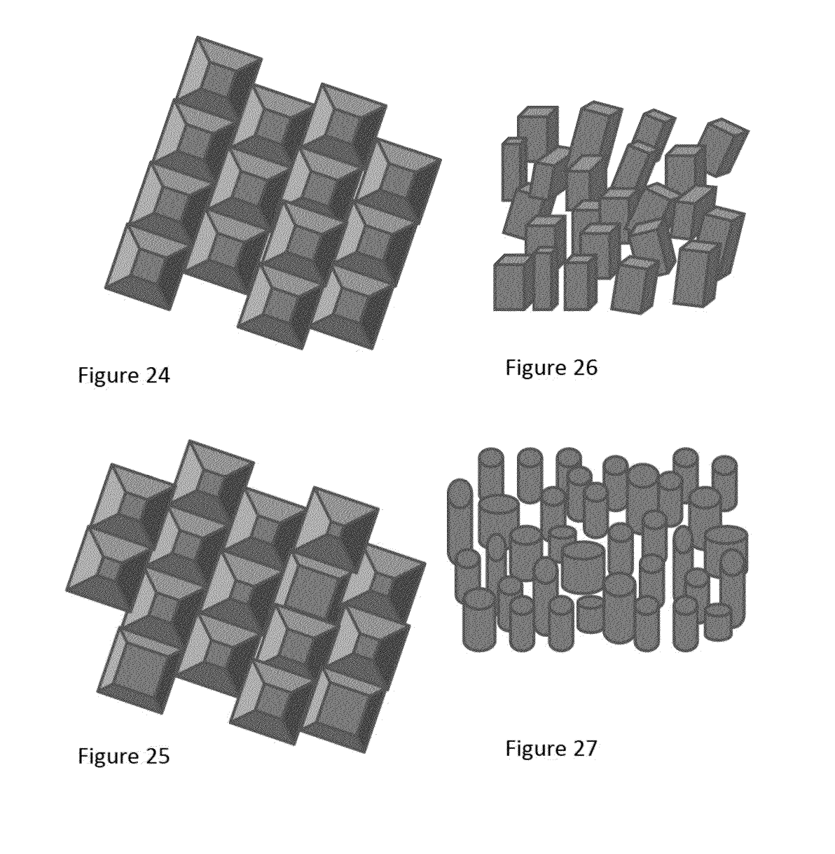

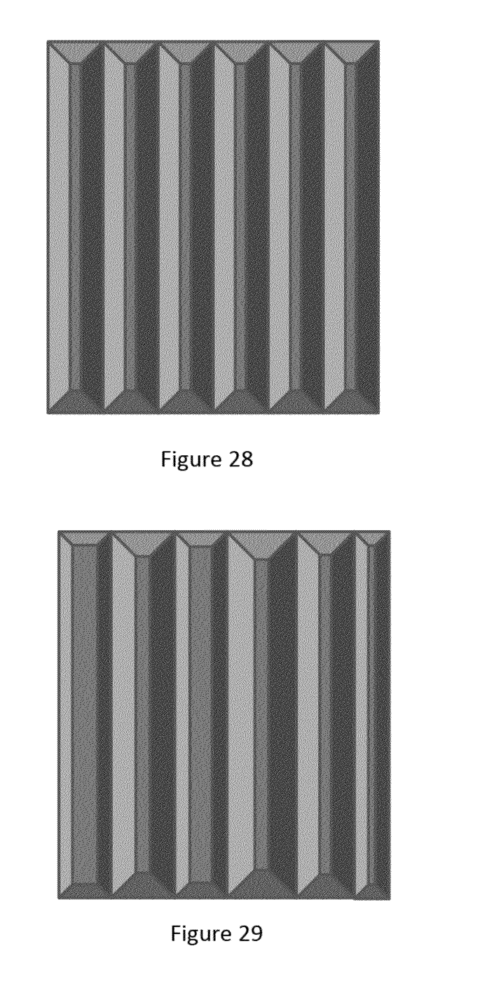

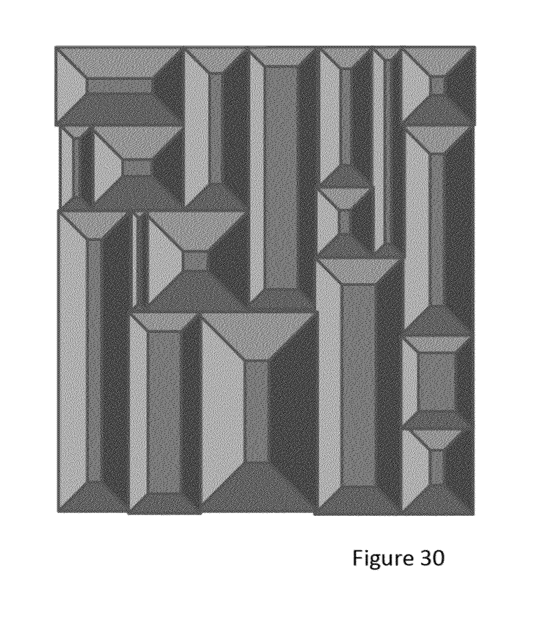

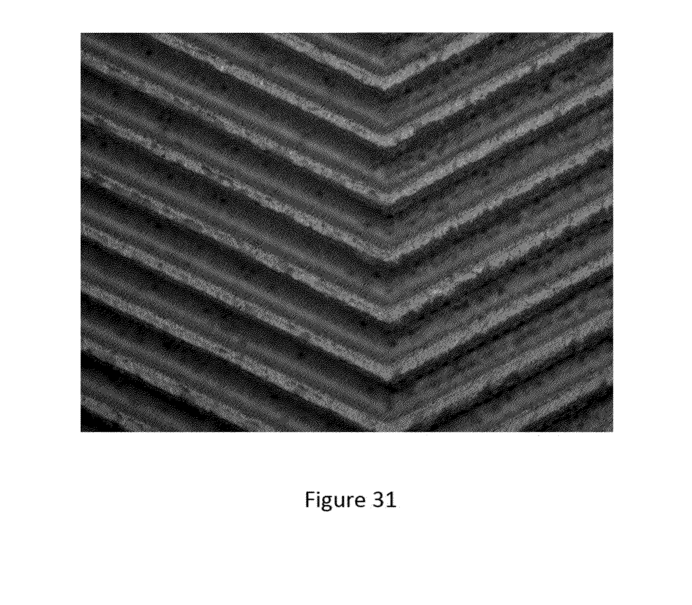

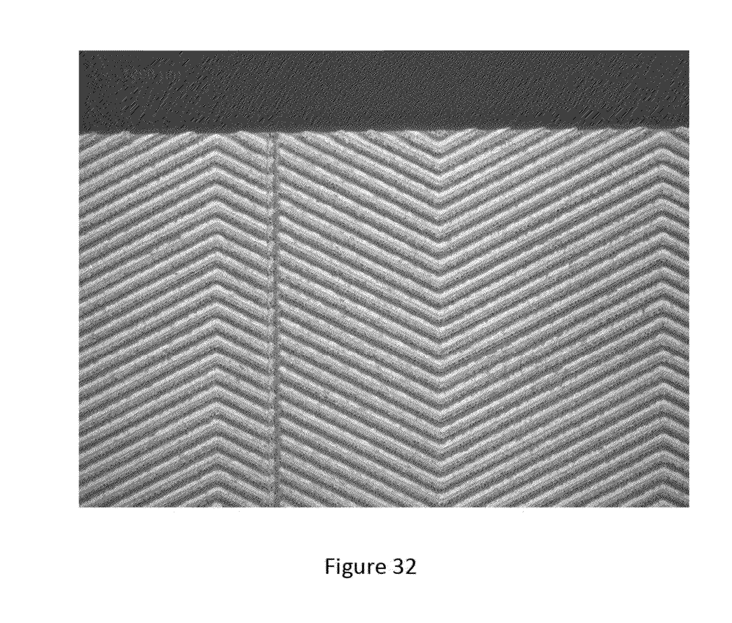

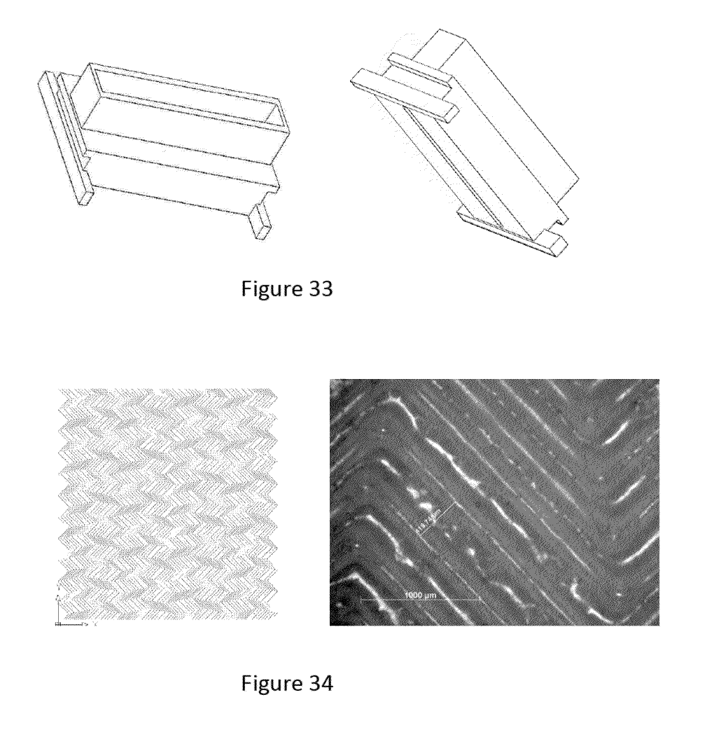

The grid is illustrated in FIGS. 8 and 9 as seen from above and below. The set up is illustrated in figures #10 and #11.

The performance was illustrated as in the previous examples.

The drop channel was added 125 microliter water, which fast filled the gap between grid and slide. The filling was completely homogeneous and done in less than a second. The liquid stayed caught while moving the grid repeatedly transversally 10 mm back and forth manually.

During washing, 2000 micoliters of water was dispensed into the drop channel. The water slowly sipped from the drop channel and over the side of the slide. During movement of the grid, the flow rate seemed to increase.

The entire experiment was repeated with water containing Tween 20. Again, the gap between the grid and slide was filled within a second. No other difference in performance was observed.

A sample of the Tween20 containing water was shaken to form foam and bubbles and dispensed into the drop channel. The air bubbles disappeared before entering the gap between the slide and grid. It was not possible to observe any air bubbles in the gap.

### Example #5

The manual testing set up was substituted with a fully controllable fixture. The grid was mounted to a frame with blade springs, giving a down force of about 8 grams. (The weight of the grid was 4 grams).

The frame was mounted to a movable stage (originally from an optical testing stage) driven by a step motor controlled by a computer. The grid could be moved upto 10 mm transversally. The slide was mounted to an adjustable elevator at the label area. The slide was moved up to the grid, which rested on the rails.

Below the slide, a mirror, light arrangement and camera were mounted for easy recording of the performance.

Several different liquids were used, for example the previously described tween20 mixture, 0.5% w/vol Thymol blue titrated to pH 9.8 (thymolsulphonephthalein, CAS no 76-61-9, Aldrich 114545) or 1% coffee with cream (“CWC”). The latter gave a good contrast against the dark grid surface and was therefore easy to monitor.

The generation #4 grid was mounted in the stage and tested.

50 microliter 1% CWC was dispensed in the drop channel and within 1 second half of the gap was filled evenly at each side of the channel. Additional 50 microliter CWC filled the gap completely. The grid was moved 6 mm transversally back and forth with a cycle time of 8 seconds. The gap remained completely filled during 5 minutes of movement, illustrating the filling and incubation procedure.

In order to illustrate a washing procedure, the movement was stopped and 800 microliter tween20 containing water was dispensed in the drop channel. Immediately, the liquid began slowly to run over the slide edge. The movement was restarted and the slow flow continued. The liquid in the gap was fast displaced homogeneously in the gap on both sides of the channel and top and bottom. After 60 seconds, the fluid dripping out was almost clear.

Compared to a dilution series of the CWC, the liquid was judged to be lees than 0.01% CWC. Additional 800 microliter tween20 water was dispensed in the channel and the fluid dripping out was perfectly clear. Also, the gap was completely filled with the clear liquid. Only a trace amount of liquid had escaped under the top rail and was seen on the outside of the grid. It was observed, that during the grid movements, some of the liquid was drawn back to the rail and away from the label area.

In order to illustrate a procedure for emptying the drop channel directly without separating grid and slide, the drop channel was filled with 800 microliter Tween20 containing water and the grid moved 12 mm to the side. The water immediately ran out.

In order to illustrate a procedure for emptying the gap by separating grid and slide, the gap was filled with 800 microliter tween20 containing water and incubated for 1 minute as described previously. The movement was stopped and the slide gently tilted downwards and away from the grid. The majority of the liquid remained caught in the grid. The grid was cleaned by pressured air and some liquid on the slide was allowed to run off passively. The slide was gently and carefully lifted back allowing the grid rails to rest on the top and bottom of the slide. The gap was filled and the washing procedure was repeated exactly as previously described and with the same performance as observed and recorded on the cameras. Also, no air bubbles were observed.

### Example #6

### Grid Variations

Numerous grids were prepared to test the performance, including:

Generation 5, 6, 7 and 8 mixing grids were made by 3D rapid prototype printing in Nylon. The general dimensions were similar to the aluminum grid 4. The drop channel was given a small funnel, giving a height from bottom to top of 1.75 cm.

FIG. 33 illustrates the generation 8 Nylon grid with raised funnel at the drop channel and extended rails, as seen from above (left) and from below (right). FIG. 34 illustrates the fish (herring) bone structure used in generation 8 Nylon grids (left) with the zig-zag pattern designed for efficient split and recombine agitation and characteristic distances between the valley corners of about 2-4 mm. The microphotograph (right) illustrates laser cut structure with peak-to-peak distances of about 420 micrometers and peak-to-valley distances of about 70 micrometers.

In grid 5, 6, 7 and 8 the drop channel was 1, 3, 2 and 2 mm wide, respectively.

The mixing pattern was cut with the CO2 laser with a 200 micro meter spot at 500 mm/s, 40% power and 4 passes. The process time was fast.

The mixer structure was a staggered herring bone pattern with a distance between the 45 degree corners of about 2-3 millimeters. The peak-to-peak distance about 420 micrometers and peak-to-valley distances of about 70 micrometers.

For grid 5, 6 and 7 the rails was 70 micrometers high and 1 mm wide. For grid 8, the rails were 70 micrometers high, 2 mm wide and extended 5 mm out from the grid.

Grids in all the Nylon grid generations were laser treated to become predominantly hydrophilic in the mixing structure and hydrophobic on the outside and in the drop channel. Untreated grids had hydrophilic surfaces also on the outside.

The nylon grids were tested for dispensing, spreading, agitation, washing and emptying using tween20 water, Thymol blue solution and CWC as described in the previous example 5.

In summary, for all the Nylon grids, the complete filling of the gap with 100 microliters was the same or faster than for the type 4 grid. The liquid stayed caught while moving the grid 6 mm transversally back and forth with a cycle time of 8 seconds.

Substituting the various liquids during washing in the gap was similar in the nylon grid in comparison to the aluminum grid. The mixing and dilution were apparently slightly faster, as judged by e.g. the changing CWC contrast.

During washing, 2000 microliters of water was dispensed into the drop channel. The water sieved from the drop channel and over the side of the slide. During movement of the grid, the flow rate seemed to increase even further.

Also, by filling the drop channel with more wash buffer volume, the flow speed could be further enhanced.

Emptying the gap was similar to the grid in example 5.

The main difference between the grids was the tendency for the grids with hydrophilic outer Nylon surface to draw a small amount of e.g. dyed solution away from the mixing structure and to the outer edge of the grid.

This is in contrast to the grids with hydrophobic outer surface, where small amount of liquids escaping under the rails seemed to be sucked back under the rail during agitation of the grid. The hydrophobic barrier was highly efficient in confining the liquid between the slide and the grid during e.g. agitation.

In general, the generation 8 grid with longer and wider rails behaved similar to the other grids. Studying the video film of the fluidic movements showed that some liquid drops escaped to the end of the longer rails but were brought back into the gap during the next movement cycle. Any liquid escaping into the label area of the slide was also sucked back into the gap during agitation.

### Example #7

### Control Mixer Experiments

In order to further explore the efficiency of the mixing and agitation on the slide, a series of control experiments were conducted with and without a micro structured surface.

Below the slide arrangement, a mirror, light arrangement and video recording camera were arranged for easy recording of the fluidics behavior on the slide.

A number of microscope slides were treated with a single drop of the thymol solution (50 microliters) on various positions on the slide, including at the top, bottom, center and close to the side edge. The drop was allowed to dry out completely to form a solid dye precipitate. For one set of experiments, a generation 8 grid was mounted in the stage as previously described, allowing the grid to be moved automatically +/−4 mm transversally back and forth with a speed of 2.5 mm/s.

For the generation 8 grid with structured surface and open drop channel, liquid could be dispensed as previously described.

For comparison, in another experiment, a generation 8 grid was mounted in the stage as previously described with a standard microscope slide covering the microstructure. At the top and bottom of the microscope slide 70 micrometer high and 1 mm wide rails made of glass were glued (cyanoacrylate) to the slide.

The arrangement was therefore equal to the original set-up, except for the use of a flat glass surface instead of the microstructured grid surface. Also, the transversal movements and video recording arrangement were the same.

The capillary gap between the two flat microscope slides could be filled with Thymol blue solution or water with tween20 by automatically moving the upper slide mounted to the grid fixture to the side and dispensing the liquid to the slide.

For both both experiments, slides with dried out dye spots were placed in the set up and the capillary gap filled with approximately 800 microliter plain water, the grid moved back and forth transversally.

The dissolving of the dye and the spreading was video recorded for later slow motion analysis.

For the flat grid with no structure elements in the surface, the dye slowly dissolved and spread only in the transversal direction. The dye stayed as a distinct and clear blue band in the direction of the grid movement. After 5 minutes there was no spreading from the original dye spot in the length direction of the slide. The only spreading was slowly along the edge of the glass slide and due to passage of the flat grid over the microscope slide edges.

After 10 minutes, some dye migrated to a different position on the slide but stayed in a distinct band across the slide.

This was repeated for slides with dye spots placed in various positions. The result was equivalent, with some minor difference in how the distinct bands were slowly distributed across the slide.

For the generation 8 grid with structure elements in the surface, the dissolving and spreading of the dye was fast. During the first movement cycle, the dye had spread evenly from the original spot and to the slide edge and several cm in the length direction, forming an ellipsoid shaped dye zone, which expanded during each movement cycle. After 8-10 cycles, the dye was spread homogeneously to more than half of the slide area. Some mixing action could be observed coming from the drop channel edges. This added to the dye spreading in the length direction.

Spreading via the slide edge, could not be distinguished from the rest of the spreading mechanism. During the agitation, the herring bone microstructure could be clearly seen.

This experiment was repeated for slides with dye spots placed in various positions. The spreading results were almost identical.

For the slide with dye spots positioned on the slide near the rails, it was possible to observe how the dye reached the rail area and spread along the inner side of the rail. Some dye spread to the end of the rail and could be seen sucked back during the reversible movement in each cycle. Also, some dye escaped under the rail but was sucked back during the next cycle.

In none of the above experiments dye water dripped out from the slide.

### Example #8

### Rail Endurance Test

The grid rail wear properties during agitation were tested in a worst case endurance tests. A CO2 laser was used to drill a series of holes into the rails on generation 4 grid made of aluminum and generation 8 grid made of nylon at about 1-2 micrometer depths and about 2 micro meters in diameter.

Both grids were mounted to the automatic stage in a frame with adjustable blade springs, giving a down force of about 8 grams.

The grids were each moved 6 mm transversally back and forth with a cycle time of 8 seconds on a dry microscope slide.

After more than 2.000 cycles back and forth, the generation 4 aluminum grid had produced visible scratch marks in the glass slide. After analysis of the grid rails and slide surface in an optical microscope, the uneven scratch pattern appears to be due to glass debris or particles.

Also, the height of the rails was apparently reduced from 70 micrometers to about 50 micrometers on average, as measured in the optical microscope. Apparently, the slide edge contributed to the scratching and wear.

The generation 8 Nylon grid produced no marks on the slide at all.

The same nylon grid was further tested over the next weeks and moved 6 mm transversally back and forth with a cycle time of 8 seconds on a dry microscope slide. After more than 349.000 cycles the nylon rail was inspected and photographed. Some wear could be detected on the rail. The wear down was less than 1 micron, as the laser drilled holes were all intact. No scratch marks were observed on the slide.

In conclusion, the nylon material is more abrasion resistant than the aluminum during prolonged operation.

### Example #9

### IHC Staining Experiments

A series of IHC staining experiments was conducted to quantify the effect of the agitation during specific reagent incubation.

The specific purpose of the experiment was to estimate the efficiency of the grid movement during staining. This was done by isolating the washing procedure and visualization system from the grid mixing action during primary reagent incubation.

The IHC protocol in short: 5 micron human tonsil FFPE tissue on Super Frost slides (Thermo Scientific) were baked (60° C., 60 minutes) in a laboratory oven, dewaxed in histoclear (Thermo-Fisher), rehydrated in ethanol/water baths and target retrieved in PT module (LabVision—Thermo Fisher and AH Diagnostics) according to standard protocol using pH 9 Tris/EDTA (heat up, 97 C, 25 min, 20 min cool down). After staining, the tissues were dehydrated by water/ethanol baths and histoclear, before being cover slipped with an organic mounting media (Ultra mount).

Only the antibody incubation time was varied in this experiment and the visualization steps (HRP/DAB Envision K4007, US Dako, carpinteria, CA-USA) done according to the recommended product protocol, including the peroxidase block (5 min), polymer conjugate incubation (100 micro liter, 30 min) and the final DAB chromogen staining (200 micro liter, 3 min). A standard wash buffer (TBST) was used.

Three series of experiments were conducted on the slide stage set-up from example 5, with sequentially reduced primary antibody incubation time (100, 50, 25 and 10% of the recommended time):

Series A: (Manual reference staining on the stage) No grid mounted and passive reagent incubation and washing by running buffer and tapping and removal of liquid from slides. All done over a standard humidity staining tray filled with water.

Series B: Grid mounted and no movements. Wash as in manual staining

Series C: Grid mounted and movement (+/−4 mm 2.5 mm/s) and washing as in manual staining.

In parallel a series D reference IHC stainings was run on an automated stainer (Autostainer 48S, Thermo Scientific), using the recommended protocols and same incubation times. The Autostainer use a robotic dispensing system on horizontally mounted slides and has no reagent agitation on the slide.

For each series, the staining quality and intensity were evaluated, in addition to any damage of morphology or detachment of tissue sections.

Using primary antibody against human epidermal keratins (Cytokeratin, AEI/AE3, BioCare, and diluted 1:900) as the primary specific reagent, the series C after grid movement and after 15 or 7 minutes of antibody incubation gave a higher or equivalent staining intensity as compared to series A, B and D with incubation of 30 minutes, which is the recommended incubation time. The series C staining intensity after 30 minutes was equivalent to the other series with the same 30 minutes incubation time.

With reduced incubation times at 15 and 7 minutes, series A, B and D all gave +1 to +2 lower intensity, respectively, as compared to the grid series C with same reduced incubation time.

With reduced incubation times to 3 minutes, series A, B and D all gave unacceptably low and uneven staining intensity, whereas series C gave a somewhat weak (+1), but acceptable and even staining intensity.

In general, the series A, B and D gave the same overall staining intensity for the same incubation times, though series B gave an insignificantly lower staining intensity and series D gave a more reproducible staining and insignificantly higher staining intensity.

During the testing no problems with detached or loosened tissue or damaged tissue morphology were observed.

1. A method for distributing and agitating an amount of a liquid over a microscope slide, comprising:
(a) providing a distribution plate defining an upper surface and a microtextured lower surface, and at least one passage extending through the plate from the upper surface to the lower surface thereof;
(b) securing the distribution plate at a predetermined distance of 10-250 μm above the microscope slide with the lower surface of the distribution plate facing an upper surface of the microscope slide and with the distribution plate essentially overlapping the microscope slide, whereby a gap of 10-250 μm is provided between the upper surface of the microscope slide and the lower surface of the distribution plate;
(c) subsequently causing the liquid to pass through said passage in a direction from a passage inlet at the upper surface of the distribution plate towards a passage outlet at the lower surface of the distribution plate;
(d) transversely reciprocating the distribution plate relative to the microscope slide in a direction substantially parallel to the plane of the lower surface of the distribution plate or the plane of the upper surface of the microscope slide, while said liquid is present in the gap between the upper surface of the microscope slide and the lower surface of the distribution plate;
(e) causing at least some of the amount of liquid, which exits said passage outlet at the lower surface of the distribution plate to distribute equally in said gap between the upper surface of the microscope slide and the lower surface of the distribution plate under the action of capillary forces caused by the surface tension between the liquid and the microtextured lower surface of the distribution plate.

2. A method according to claim 1, wherein the lower surface of the distribution plate is microtextured over an area of at least 70% of its total surface area.

3. A method according to claim 1 or 2, wherein at least 50% of the lower surface of the distribution plate is non-planar.

4. A method according to claim 1, wherein any straight-line distance, measured in the plane of the lower surface of the distribution plate, between neighbouring indentations, grooves or protrusions forming the microtextured pattern of the lower surface of the distribution plate is smaller than an amplitude of the reciprocating movement of the distribution plate relative to the microscope slide.

5. A method according to claim 1 further comprising, subsequent to steps (b), (c), (d) and (e), the further steps of:
cleaning the distribution plate and the microscope slide by causing an amount of a washing liquid to flow across the distribution plate and the microscope slide; and
separating the distribution plate and the microscope slide to allow the washing liquid to be removed from the distribution plate and the microscope slide;
and subsequently:
repeating steps (b), (c), (d) and (e).

6. A method according to claim 1, further comprising, subsequent to steps (b), (c), (d) and (e), the further step of emptying the passage by moving the distribution plate and the microscope slide relative to each other to a position, in which the passage outlet is beyond the microscope slide.

7. A method according to claim 1, wherein there is no flow of liquid into or out of the gap between the microscope slide and the distribution plate, while the distribution plate and the microscope slide are being mutually reciprocated, when the liquid is a reagent solution.

8. A method according to claim 1, wherein a flow of the liquid into and out of the gap between the microscope slide and the distribution plate is provided, while the reciprocating movement occurs, when the liquid is a washing liquid.

9. A method according to claim 1, wherein the gap between the microscope slide and the distribution plate is in fluid communication with a surrounding atmosphere.

10. A method according to claim 1, wherein said liquid comprises at least one of a liquid reagent and a liquid wash buffer.

11. A method according to claim 1, wherein excess liquid, which is not accommodated in said gap between the upper surface of the microscope slide and the lower surface of the distribution plate, is caused to flow off one or more edges of the microscope slide.

12. A system for distributing and agitating an amount of a liquid over a microscope slide, comprising:
a distribution plate defining an upper surface and a microtextured lower surface, and at least one passage extending through the plate from the upper surface to the lower surface thereof;
a mechanism for securing the distribution plate at a predetermined distance of 10-250 μm above the microscope slide with the lower surface of the distribution plate facing an upper surface of the microscope slide and with the distribution plate essentially overlapping the distribution plate;
a supply of the liquid arranged to cause the liquid to pass through said at least one passage in a direction from a passage inlet at the upper surface of the distribution plate towards a passage outlet at the lower surface of the distribution plate;
a structure for transversely reciprocating the distribution plate relative to the microscope slide in the plane of the lower surface of the distribution plate or the plane of the upper surface of the microscope slide.

13. A system according to claim 12, wherein the mechanism for securing the distribution plate above the microscope slide comprises a pair of rails at or near respective parallel side edges of the microscope slide.

14. A system according to claim 13, wherein said rails are provided at respective parallel side edges of the microscope slide extending transversely to a longitudinal direction of the slide.

15. A system according to claim 8, wherein said microtextured lower surface of the distribution plate comprises a pattern of grooves having a depth of between 10 and 200% of the distance between the upper surface of the microscope slide and the lower surface of the distribution plate.

16. A system according to claim 12, wherein said microtextured lower surface of the distribution plate comprises at least one of:
a pattern of zig-zag grooves;
a pattern of staggered grooves;
a pattern of herringbone grooves;
a pattern of staggered herringbone grooves;
a chessboard pattern.

17. A system according to claim 12, wherein said at least one passage comprises one of:
a hole provided centrally in the distribution plate;
a matrix of a plurality of holes distributed over the distribution plate;
a slit extending a longitudinal direction of the plate;
a slit extending transversely to a longitudinal direction of the plate.

18. An automated apparatus for staining of a plurality of biological samples arranged on microscope slides held in mutually fixed positions in a frame, said automated apparatus comprising:
a system according to claim 12;
a liquid reagent supply for supplying a liquid reagent to the system;
a liquid wash buffer supply for supplying a liquid wash buffer to the system;
a controller for controlling the supply of said liquids to said passage, wherein the controller is configured to supply the liquid reagent to at least one of the microscope slides held in the frame and to simultaneously supply the liquid wash buffer to at least another one of the microscope slides held in the frame.

19. A distribution plate for a system according to claim 8 for distributing a liquid over a microscope slide, the plate defining an upper surface and a microtextured lower surface and at least one passage extending through the plate from the upper surface to the lower surface thereof.

20. A distribution plate according to claim 19, wherein at least a circumferential inner surface of said passage is hydrophobic.
